(19) United States
(12) Patent Application Publication
(10) Pub. No.: US 2024/0020638 A1
(43) Pub. Date: Jan. 18, 2024

(54) SYSTEMS AND SOFTWARE FOR STATE-BASED MONITORING AND CONTROL OF POWERED DEVICES

(71) Applicant: BLACK & DECKER INC., New Britain, CT (US)

(72) Inventors: Steve Adcock, Akron, OH (US); Robert George Osterwise, Cumming, GA (US); Jon Frederick Loeliger, Ellicott City, MD (US)

(73) Assignee: BLACK & DECKER INC., New Britain, CT (US)

(21) Appl. No.: 18/353,399

(22) Filed: Jul. 17, 2023

Related U.S. Application Data
(60) Provisional application No. 63/389,525, filed on Jul. 15, 2022.

(51) Int. Cl. G06Q 10/087

(52) U.S. Cl. CPC G06Q 10/087

(57) ABSTRACT

Systems, methods, and computer software are disclosed where sensor data is received from sensors operatively connected to a powered device. Based on the sensor data, an inventory of detectable items proximate the powered device is generated. The inventory of detectable items is compared to an expected inventory of detectable items that are expected to be proximate the powered device. An alert is generated at a client device when the inventory of detectable items does not match the expected inventory of detectable items.

### RELATED APPLICATION(S)

This application claims priority to and the benefit of U.S. Provisional Application No. 63/389,525, filed Jul. 15, 2022, titled “Systems And Software For State-Based Monitoring And Control Of Powered Devices,” which is hereby incorporated by reference.

### DESCRIPTION OF THE RELATED ART

Powered devices such as construction or landscaping tools may be utilized in a wide variety of environments and under a wide range of operating conditions. Use of such powered devices under such varying conditions can result in seemingly unpredictable wear and tear on the powered devices. Also, powered devices are typically provided with predetermined and standardized power sources under the presumption that such power sources will be sufficient for any application.

### SUMMARY

Systems, methods, and computer software for monitoring and control of powered devices are disclosed.

In one aspect, a system includes: a powered device; at least one programmable processor; and a non-transitory machine-readable medium storing instructions which, when executed by the at least one programmable processor, cause the at least one programmable processor to: receive sensor data from sensors operatively connected to a powered device; generate, based on the sensor data, an inventory of detectable items proximate the powered device; compare the inventory of detectable items to an expected inventory of detectable items that are expected to be proximate the powered device; and generate an alert at a client device when the inventory of detectable items does not match the expected inventory of detectable items.

In some variations, the powered device can be a battery-operated outdoor device, a mower, a power drill, a handheld mower, or an electric saw.

In some variations, the instructions, when executed, further cause the at least one programmable processor to: generate, at the client device, a last known location of an item from the expected inventory that is not in inventory.

In some variations, the instructions, when executed, further cause the at least one programmable processor to: repeatedly generate the inventory over a period of time based on repeated acquisitions of the sensor data; monitor the inventory to determine whether the inventory meets a threshold condition for generating the alert; and generate the alert when the threshold condition is met.

In some variations, the threshold condition is a time since last detected for an item in the expected inventory exceeding a maximum time since last detected.

In some variations, the threshold condition is a distance for an item in the expected inventory having a last known location exceeding a maximum distance from the powered device.

In some variations, the instructions, when executed, further cause the at least one programmable processor to: perform the comparing when the powered device crosses a speed threshold that is greater than a top speed of the powered device.

In some variations, the instructions, when executed, further cause the at least one programmable processor to: input inventory sets of powered devices as training data to a machine learning model; train the machine learning model to determine when an item is missing from an input inventory; input the inventory into the machine learning model; and determine, with the machine learning model, that the alert should be generated.

In an interrelated aspect, a system includes a powered device; at least one programmable processor; and a non-transitory machine-readable medium storing instructions which, when executed by the at least one programmable processor, cause the at least one programmable processor to: receive sensor data from sensors operatively connected to a powered device; and transmit the sensor data to a server; build, at the server, a first historical database of energy requirements for the powered device; determine a required amount of energy for the powered device based on the first historical database and a second historical database containing past energy requirements for use of similar powered devices; and receive, at a client device, an indication representing the required amount of energy for the powered device.

In some variations, the instructions, when executed, further cause the at least one programmable processor to: determine, based on a battery inventory, whether an available amount of energy in the battery inventory is at least the required amount of energy; and generating a notification at the client device when the available amount of energy is less than the required amount of energy.

In some variations, the required amount of energy is further determined based on a proposed time of use of the powered device.

In some variations, the instructions, when executed, further cause the at least one programmable processor to: monitor a state of the powered device over a period of time; determine a recommended change to the powered device based on the monitoring; and cause the recommended change to be displayed at the client device.

In some variations, the instructions, when executed, further cause the at least one programmable processor to: monitor a state of the powered device over a period of time; determine a predicted failure mode of the powered device based on the monitoring; and cause an alert indicative of the predicted failure mode to be displayed at the client device.

Item 60: The system as in any one of the preceding Items, wherein the predicted failure mode is determined by a machine learning model utilizing the state of a battery of the powered device.

In some variations, the predicted failure mode is an end-of-life of the battery, and the alert indicates the predicted failure mode and/or an estimated time for the end-of-life of the battery.

In some variations, the indication also includes a representation of a battery charge, an energy use rate, an energy remaining, a use time, or a battery efficiency.

In some variations, the instructions, when executed, further cause the at least one programmable processor to: input data from the second historical database as training data to a machine learning model and properties where the similar powered devices were used; train the machine learning model to determine the required amount of energy; input a device identification for the powered device and a property identification into the machine learning model; and determine, with the machine learning model, the required amount of energy for the powered device at the property.

In an interrelated aspect, a system includes: a powered device; at least one programmable processor; and a non-transitory machine-readable medium storing instructions which, when executed by the at least one programmable processor, cause the at least one programmable processor to: receive sensor data from sensors operatively connected to a powered device; determine a state of the powered device based on the sensor data associated with one or more components of the powered device; receive, at a server, tracking data for the powered device; and determine, at the server and based on the state and the tracking data, a property location where the powered device provided the tracking data and the sensor data; build a historical database based on the state and the tracking data; and associate the state and sensor data with the property location.

In some variations, the instructions, when executed, further cause the at least one programmable processor to determine, based on the property location, a property address by utilizing a database that relates locations to property addresses.

In some variations, the instructions, when executed, further cause the at least one programmable processor to determine a job designation comprising a specific occurrence of operation of the powered device at the property location.

In some variations, the instructions, when executed, further cause the at least one programmable processor to determine a percent of completion of a current job based on comparison with the job designation.

In some variations, the instructions, when executed, further cause the at least one programmable processor to generate a prompt for a user to confirm the job designation as a current job and, once confirmed, store the current job in computer memory.

In some variations, the instructions, when executed, further cause the at least one programmable processor to add metadata to the job designation based on input from a user interface.

In some variations, the instructions, when executed, further cause the at least one programmable processor to: input historical tracking data during use of powered devices at the property location as training data to a machine learning model; train the machine learning model to determine a boundary of the property location; input the tracking data into the machine learning model; and determine, with the machine learning model, an updated boundary of the property location.

In an interrelated aspect, a system includes: a powered device; at least one programmable processor; and a non-transitory machine-readable medium storing instructions which, when executed by the at least one programmable processor, cause the at least one programmable processor to: receive sensor data from sensors operatively connected to a powered device; receive supplemental sensor data comprising information indirectly related to operation of the powered device; determine a state based on the sensor data associated with one or more components of the powered device; receive a time of availability of the powered device; determine a time of use of the powered device based on the state of the powered device; and generate, at a client device, a productivity metric based on the time of use, the supplemental sensor data, and the time of availability.

In some variations, the instructions, when executed, further cause the at least one programmable processor to: compare the productivity metric with a historical average productivity metric; and generate an alert at a client device when the productivity metric is below the historical average productivity metric.

In some variations, the instructions, when executed, further cause the at least one programmable processor to: determine an electrical load of the powered device during the time of use, wherein the productivity metric is further based on the electrical load.

In some variations, the instructions, when executed, further cause the at least one programmable processor to: input historical times of use of powered devices, historical times of availability of the powered devices, and historical productivity metrics as training data to a machine learning model; train the machine learning model to determine the productivity metric; input the time of use and the time of availability into the machine learning model; and determine, with the machine learning model, the productivity metric.

Implementations of the current subject matter can include, but are not limited to, methods consistent with the descriptions provided herein as well as articles that comprise a tangibly embodied machine-readable medium operable to cause one or more machines (such as computers, etc.) to result in operations implementing one or more of the described features. Similarly, computer systems are also contemplated that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or across multiple computing systems. Such multiple computing systems can be connected and can exchange data and/or commands or other instructions or the like via one or more connections, including but not limited to a connection over a network (such as the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a collection of powered devices networked to a server that is in communication with one or more client devices in accordance with certain aspects of the present disclosure.

FIG. 2A illustrates a system configured to generate alerts based on sensor data from a powered device in accordance with certain aspects of the present disclosure.

FIG. 2B illustrates a system for detecting items expected to be proximate a powered device in accordance with certain aspects of the present disclosure.

FIG. 2C illustrates a process for generating alerts when a detectable item is not proximate a powered device in accordance with certain aspects of the present disclosure.

FIG. 2D illustrates an example of determining an accuracy value of a last known location of a detectable item in accordance with certain aspects of the present disclosure.

FIG. 3 illustrates a process flow for utilizing historical state data to generate alerts about a powered device in accordance with certain aspects of the present disclosure.

FIG. 4 illustrates a simplified machine learning model in accordance with certain aspects of the present disclosure.

FIG. 5A illustrates an exemplary graphical user interface (GUI) displaying metrics indicative of a status of a powered device in accordance with certain aspects of the present disclosure.

FIG. 5B illustrates an exemplary graphical user interface (GUI) displaying metrics indicative of a status of a powered device in accordance with certain aspects of the present disclosure.

FIG. 5C illustrates an exemplary process for determining property and/or job locations in accordance with certain aspects of the present disclosure.

FIG. 5D illustrates examples of tracking data for a powered device in accordance with certain aspects of the present disclosure.

FIG. 5E illustrates an example of a job designation in accordance with certain aspects of the present disclosure.

FIG. 5F illustrates an exemplary process for determining a productivity metric in accordance with certain aspects of the present disclosure.

FIG. 6A illustrates an exemplary process for determining a required amount of energy for a powered device in accordance with certain aspects of the present disclosure.

FIG. 6B illustrates an exemplary graphical user interface displaying metrics of a battery for a powered device in accordance with certain aspects of the present disclosure.

FIG. 7 illustrates a data flow diagram of an example of a PaaS program and related metrics and analytics in accordance with certain aspects of the present disclosure.

### DETAILED DESCRIPTION

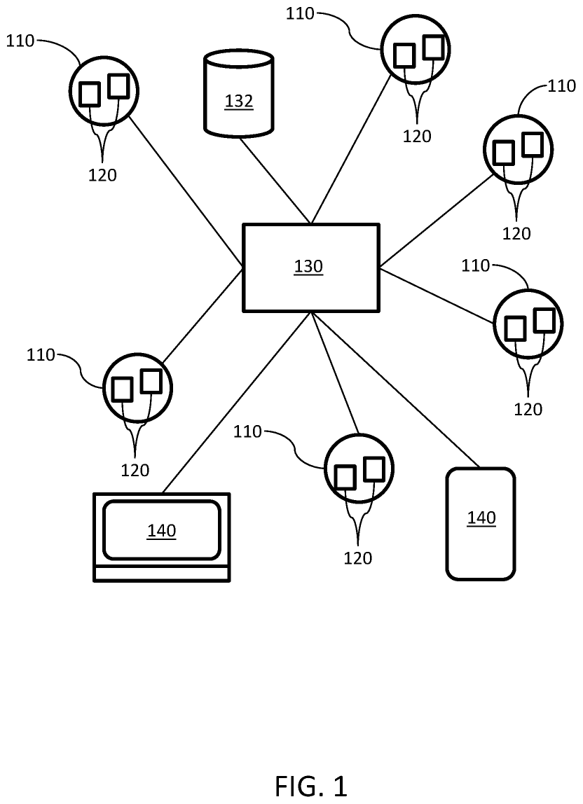

FIG. 1 illustrates a collection of powered devices 110 networked to a server 130 that is in communication with one or more client devices 140 in accordance with certain aspects of the present disclosure. Customers may deploy powered devices 110 at various geographic locations.

Powered devices 110 can include, for example, landscaping tools such as electric lawnmowers or hedge trimmers, construction tools such as drills or saws, machining tools such as milling machines or lathes, and/or other types of tools. In general, powered devices 110 as described herein can include any device that receives power from a power source (such as electrical cords, batteries, etc.). Other examples of powered devices can include, for example, “walk behind tools” (e.g., push mowers, self-propelled walk-behind mowers, snowblowers, etc.), “Ride on tools” (e.g., riding mowers, zero turn mowers, bucket loaders, etc.), and “handheld tools” (e.g., chainsaws, backpack leaf blowers, trimmers, etc.).

In some embodiments, powered devices 110 may include a removable power supply such as a battery. In some embodiments described herein, powered devices 110 may include sensors or other electronics integrated into the powered device to provide data about the device's status, condition, location, etc.

The server 130 may analyze the data to monitor the state of a number of powered devices, for example, to provide real-time information about their condition, alerts about device failures, etc. The server 130 may also analyze the data to predict what powered device may be best for the desired application, what the power/energy needs may be (such as battery size/type), etc. For example, as shown in FIG. 1, some disclosed embodiments can include systems and computer program instructions such as software, firmware, etc. configured to receive sensor data from sensor(s) 120 (such as battery sensor, position sensor, etc.) operatively connected to powered device(s) 110. A state of a powered device 110 may refer to an operational or environmental condition of the powered device. For example, a state may refer to a current energy level (such as such as current battery charge) of the powered device 110, usage information (such as hours powered on or used in a day), temperature of a component or environment, emissions generation, fuel or energy consumption, geolocation information, and/or other operational or environmental condition. The state of the powered device 110 can be determined based on the sensor data associated with one or more components (such as a battery, a drive train for a cutting blade, etc.) of the powered device. Also, state information can be transmitted (such as transmitting data about the state via one or more server(s) 130 or other networking system) to one or more client device(s) 140 about the powered device based at least on the state of the powered device. For example, if the state indicates a fault then the system can transmit such state information based on detecting the fault. Examples of client device(s) 140 can include personal computers, laptop computers, smartphones, tablet computers, etc. The state information can also be transmitted to computers such as servers for processing and analysis as described for numerous embodiments herein, without necessarily passing on the state information to client devices such as smartphones, workstations, etc. For example, state information such as tracking data for one or more powered devices can be collected at a server, with the tracking data then analyzed as part of fleet management as described herein. As used herein, when referring to a powered device or a client device, such is understood to also describe embodiments having any number (not just one) of such devices.

The server 130 may provide predictive analytics, data, and functionality relating to the powered devices 110. For example, in some embodiments, the server 130 may include one or more computing devices that train and execute machine-learning models for predictive analytics, facilitate fleet management of the powered devices 110, implement a networked architecture for a Power as a Service (PaaS) program for the powered devices 110, and/or perform other functions.

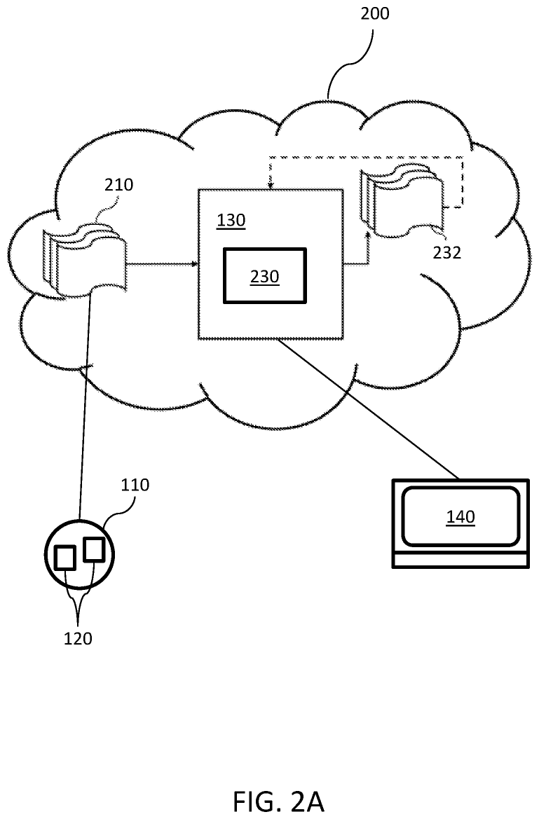

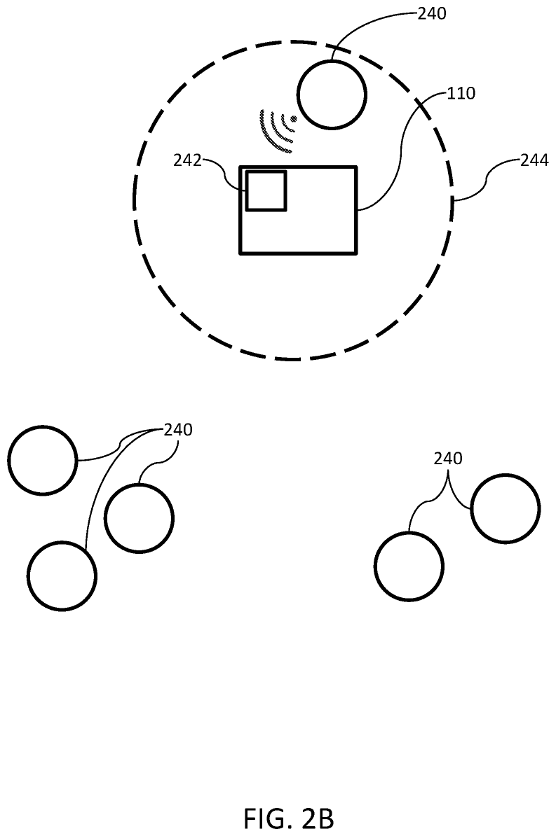

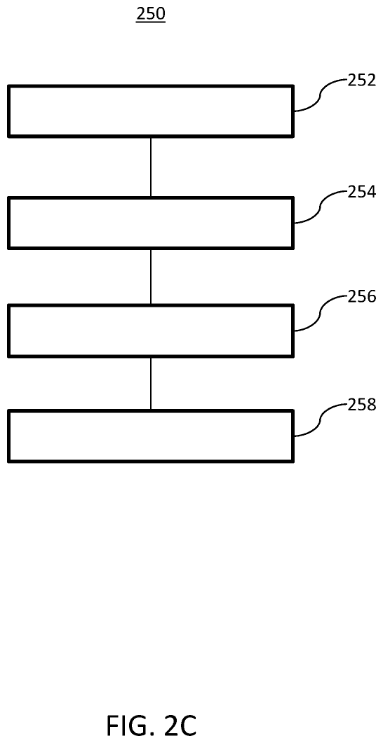

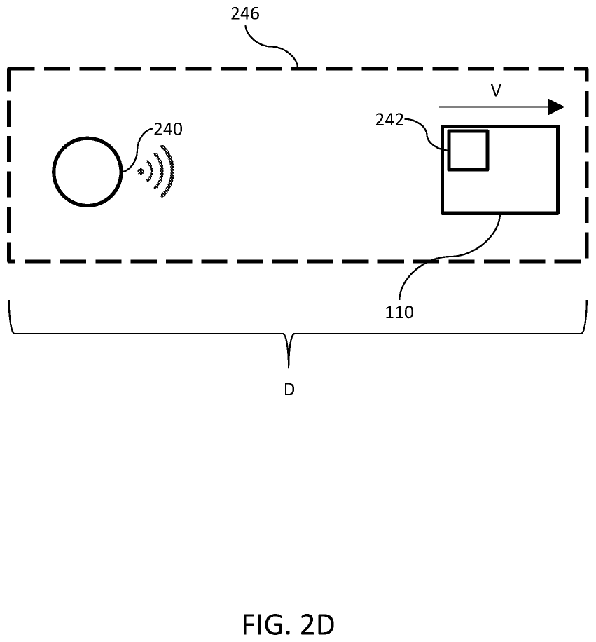

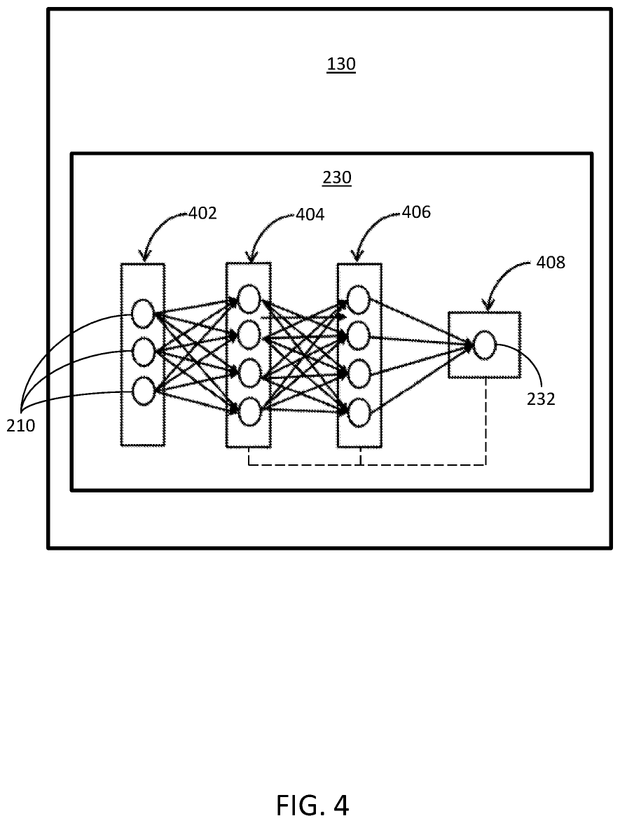

The predictive analytics may be based on machine-learning models trained on historical and/or current data relating to the powered devices 110. The server 130 may activate a machine-learning model (such as a machine-learning model 230 illustrated in FIGS. 2A and 4) trained to predict one or more outcomes based on the historical and/or current data. The predicted outcomes may relate to a need for service and maintenance of the powered device 110 (including one or more their components), forecasted power needs, and/or other aspects of the powered devices 110.

To predict a need for service and maintenance, the server 130 may receive sensor data from a sensor 120 of a powered device 110. The server 130 may activate a machine-learning model (such as machine-learning model 230 illustrated in FIGS. 2A and 4) trained on historical sensor data leading up to powered device 110 failure. To activate the machine-learning model, the server 130 may execute the machine-learning model using the received sensor data as input to the model. The prediction may be made prior to failure, thereby reducing downtime and potentially preventing further damage to the powered device 110.

To predict forecasted power needs, the server 130 may analyze a known number of components such as batteries in use by various entities, such as an account holder that participates in the PaaS program, compared to the number of deployed powered devices 110. In this way, the server 130 may forecast battery needs of a customer based on the customer's number of deployed powered devices 110. Based on the forecast, a number of batteries may be allocated to the customer under the PaaS program. Other predictions may be similarly made based on the training and activation of machine-learning models.

The predictions may be provided separately or in connection with fleet management. Fleet management may refer to data, analytics, and functionality relating to powered devices 110 deployed by a given customer. For example, fleet management may include asset management, operational insights, maintenance, safety, security and loss prevention (such as through remote control of the powered devices 110), total cost of ownership analytics, and/or other data or functionality.

Asset management may include data for tracking powered devices 110. Such tracking data may include location data such as GPS location data, operational status data regarding the powered devices 110 or components such as a current battery charge level, and/or other real-time data of the powered devices 110. Operational insights may include analytics relating to statistics of the powered devices 110 or components such as runtimes, powered on times, energy usage, breaks, and so forth. Maintenance alerts and notifications may be based on predetermined usage times, machine-learning models, diagnostic codes (DTCs) that include signals from the powered devices 110, and/or other alerts for maintenance and service. Safety information may include data relating to safe (or unsafe) use of the powered devices 110. For example, safety information may include a speed, orientation (including level of incline), and/or other operational data that relate to safe operation of the powered devices 110. Security and loss prevention may relate to automatically and/or remotely locking or unlocking powered devices 110. For example, the powered devices 110 may be equipped with remove disable capabilities that are accessible through the server 130. Total cost of ownership may include analytics relating to operational costs associated with the powered devices 110. These insights may include upfront costs of the PaaS program, lifetime subscription costs, maintenance costs, energy costs, and/or other costs of operating the powered devices 110.

The server 130 may implement a networked architecture for a Power as a Service (PaaS) program. For example, the server 130 may generate and maintain a database 132 that includes data structures for storing information relating to the powered devices 110, components such as batteries to be exchanged, customers that are subscribed to the PaaS program, dealers that exchange batteries for the PaaS program, and/or other entities or devices. For example, the database 132 may include a customer data structure, a battery data structure, and a provider data structure. For embodiments in which database 132 is a relational database, each of the customer data structure, a battery data structure, and a provider data structure may be implemented as one or more relational tables in the relational database. For other types of databases, each of the customer data structure, a battery data structure, and a provider data structure may be implemented as other types of data structures, such as marked up or labeled elements in extensible markup language (XML), object notations (JAVASCRIPT Object Notation), and/or other types of structured data.

The customer data structure may include one or more customer data fields that are structured to store customer account identifiers, each customer account identifier uniquely identifying a customer account that is subscribed to participate in PaaS program.

The battery data structure may include one or more battery data fields that are structured to store battery identifiers that each uniquely identify a battery that is to be exchanged in connection with the PaaS program. The provider data structure may include one or more provider data fields that are structured to store provider identifiers that each uniquely identify a provider that is to exchange batteries in connection with the PaaS program;

The server 130 may provide one or more interfaces to receive sensor data of the powered devices 110 and one or more interfaces to provide fleet management data and other functionality to customers and dealers.

In some embodiments, the powered device 110 may include various components that are sensed by one or more sensors 120. The components can include at least one of: a battery (in which a sensor 120 may such as monitor to provide data on available energy), a drive train (such as in which a sensor 120 may monitor a current speed of the powered device 110 or component thereof), a suspension system (such as in which a sensor 120 may monitor weight/load), a positional system such as GPS receivers, accelerometers, or gyroscopes (such as in which a sensor 120 may to monitor a current position/location/orientation), and/or other components that are sensed by a sensor 120.

In some embodiments, the system depicted in FIG. 1 can also automatically collect the sensor data from sensors 120 of the powered devices 110. Sensor data from sensors 120 can be automatically transmitted to server 130 monitoring the powered devices 110. In other embodiments, the sensor data can, alternatively or additionally, be collected and/or transmitted periodically (such as at specified times such as, by the minute, hourly daily, etc.) or intermittently (such as upon request by a server or a user).

In various embodiments, such as where it may be is desired to monitor a fleet or collection of powered devices, the sensor data can be received from a number of powered devices 110 associated with one or more users. For systems that utilize batteries, some embodiments can include monitoring states of the powered devices each having a battery. State information for the battery can then be transmitted to client device 140. Examples of state information for a battery can include one or more of: energy remaining, time of use remaining, available power output, current flow from a battery, voltage available, etc. In the present disclosure, the term “sensor data” includes other data that can be indicative of the state of the powered device. This can include, for example, error codes (or diagnostic trouble codes (DTCs)) that may be generated by onboard processors for various components of the powered device. The error codes, similar to data from actual sensors, can provide specific information about a hardware and/or software failure. In some embodiments, the server 130 may generate an alert that indicate potential safety violations. For example, the server 130 may compare sensor data to a threshold value and generate a safety alert when the sensor data deviates from the threshold value. For example, the sensor data may include a speed (travel speed of a mower, for example, or revolutions per minute of a power tool motor as another example) associated with the powered device 110 that exceeds a threshold value. Such deviation from the threshold value may indicate unsafe operation of the powered device 110. In another example, the sensor data may indicate a certain pitch or angle of incline of the powered device 110 beyond a threshold angle of incline, indicating that a mower (for example) is being operated at an unsafe hill or other physical incline, or has rolled over.

Database 132 may include one or more datastore that store sensor data, device data, dealer data, service data, and/or other data described herein. For example, the database 132 may include an archive or other non-transient memory structure that may store sensor data associated with respective sensor(s) and the powered device(s) having the sensors. Dealer data may include customer account information, data about the powered devices that were purchased, maintained, or otherwise associated with a specific dealer (or dealers). Service data may include historical information on the powered devices such as when they were last serviced, the servicing performed, customers/dealers associated with the powered devices serviced, etc. Database 132 may be a central database having information on powered devices and their associated data across many locations or may be part of a distributed data store where it is one of multiple databases that store information on a subset of powered devices and their associated data.

FIG. 2A illustrates a system configured to generate alerts based on sensor data from a powered device in accordance with certain aspects of the present disclosure. In some embodiments, the disclosed systems can be configured to use the state of the powered device to display status information about the powered device, provide alerts regarding the powered device, etc. Examples of alerts can include, for example, an online/offline alert, a missing alert, a servicing needed alert, a component failure alert, etc. FIG. 2A depicts a system 200, which may be a cloud-based computing system, where sensor data 210 (such as from a sensor 120 of a powered device 110) can be transmitted to server 130. Server 130 can then determine, based on the state of powered device 110, that an alert needs to be generated for powered device 110. An alert can then be generated for transmission to client device 140, for example, by generating push notifications, automated e-mails, or graphical/text generated at a mobile application. In some embodiments, such as those described further with reference to FIG. 4, system 200 can utilize output 232 from a machine learning model 230 to more accurately determine whether an alert is needed and/or what kind of alert the system will generate.

FIG. 2B illustrates a system for detecting items expected to be proximate a powered device in accordance with certain aspects of the present disclosure. For example, embodiments of such a system can detect the presence of tools, batteries, etc. within a certain proximity via wireless protocols (e.g., low-energy wireless or similar such technologies). The powered device could, for example, detect items within this proximity at the beginning of a day and then cause an alert to be generated when an item is no longer present within the proximity.

As shown in FIG. 2B, the depicted system includes powered device 110 and an illustration of detectable items 240. As used herein, some examples of powered devices can include battery-operated outdoor devices, for example, a mower, a power drill, a handheld mower, or an electric saw. Detectable items 240 can, for example, send out low-energy wireless signals that can be detected at sensor 242 of the powered device 110. Based on, for example, signal strength, triangulation, etc. the system can determine whether a particular detectable item 240 is within proximity 244 of the powered device 110. Proximity 244 can be a distance set by the system or a distance based on the maximum distance from detectable items 240 that sensor 242 is able to acquire signals from. Examples of proximities can include, for example, two meters, three meters, 5 meters, etc.

In the depicted example, one detectable item 240 is within proximity 244. The detectable items 240 that are outside proximity 244 can be identified by the system as lost items. In some embodiments, the powered device and the detectable items can be from the same manufacturer and/or the tracking hardware software (e.g., wireless receivers and RFID tags) can be from the same manufacturer. However, in other embodiments, the power device and detectable items can be from any combination of manufacturers. For example, the powered device may be from manufacturer A and the detectable items can be from various other manufacturers but still be configured to be detectable by the sensors of the powered device. In some embodiments, the user can be provided with an alert or query notifying them that a detectable item has been found (and optionally notifying the manufacturer of the detected item) and also optionally asking for confirmation on whether to track or monitor the detectable item.

FIG. 2C illustrates a process 250 for generating alerts when a detectable item is not proximate a powered device in accordance with certain aspects of the present disclosure.

At 252, process 250 can include receiving sensor data from sensors operatively connected to a powered device, with examples of such sensor data (e.g., data on signals into sensor 242 indicative of nearby RFID tags on detectable items, as well as other sensor data described above and throughout the present disclosure).

At 254, process 250 can include generating, based on the sensor data, an inventory of detectable items proximate the powered device. In some embodiments, which may also include any of the embodiments disclosed herein and not limited to the embodiment of FIG. 2B, relative signal strength of signals received from nearby detectable items can be used to determine a device location. For example, the system can detect when/where the sensor on the powered device is receiving the strongest signal from a detectable item. Utilizing, for example, triangulation or signal strength falloff information, the location (e.g., distance from the powered device) of the detectable item can be determined. In other embodiments, rather than determining a particular distance, sufficient signal strength from a detectable item can be utilized to designate the detectable item as within proximity 244.

An inventory of detectable items can be generated and/or updated as a table in a database or other memory structure. For example, a machine identification for a detectable item can be received as part of a broadcast from a transmitter of the detectable item. The disclosed computer system can then find (or create) a corresponding machine identification in the list corresponding to the detectable item inventory. One or more fields of the entry can be created/updated. For example, the timestamp corresponding to the broadcast, a count (e.g., a running number of times that detectable device has been detected by its broadcasts), signal strength (e.g., Received Signal Strength Indicator “rssi MAX” that can represent how close the power device was to the detectable device when the powered device detected it), summation of signal strengths (e.g., Received Signal Strength Indicator summation “rssi SUM” that can be a calculated summation of received signal strengths over a period of time—that can be utilized to calculate the overall confidence of the detectable device location, with a larger sum indicating a larger confidence due to the robustness of the received broadcasts), a GPS location (e.g., corresponding to a last known location), etc. Other data can be contained in other fields as well, such as an advertisement bit length, the data for the current advertisement, etc.

At 256, process 250 can include comparing the inventory of detectable items to an expected inventory of detectable items that are expected to be proximate the powered device. Such comparisons can include, for example, comparing the detected items with those in a database or other memory store that contain the expected inventory of detectable items. The expected inventory can be established, for example, at the beginning of the day by performing a pairing operation or similar initialization to establish what detectable items are within the proximity at that time or should be in the proximity. In some embodiments, the expected inventory can be manually adjusted by a user of the system (e.g., adding or removing items) and can also optionally include preset items (e.g., a set of items that should be with the powered device at all times).

At 258, process 250 can include generating an alert at a client device when the inventory of detectable items does not match the expected inventory of detectable items. Such alerts can be, for example, push messages to a smart phone or tablet computer, an audio alert at a client device or from the powered device, a visual indicator such as a red light at the powered device, etc.

In some embodiments, the process 250 can include generating, at the client device, a last known location of an item from the expected inventory that is not in the inventory. In some embodiments, the last known location of the item may be asked or proximate the powered device the last time that the inventory was checked. However, in other embodiments, periodic checks can be performed by the system but alerts need not be generated every time and instead at other intervals or selected times. For example, the system may be configured to detect missing items every minute, but only generate an alert if the missing items remain missing for longer than a threshold time (similar to the example described below). Accordingly, the last known location of the item can be the last recorded location before the item was outside the proximity or outside the detection range of sensor 242.

FIG. 2D illustrates an example of determining an accuracy value of a last known location of a detectable item in accordance with certain aspects of the present disclosure. In some implementations, the detectible item 240 can broadcast information containing its identity, health, activity state, battery power, and other information. The powered device 110 can scan for these items and as they are detected (such as by sensor 242), the powered device can track the broadcasts. This can include, for example, associating location information with the signal quality of the broadcast from the powered device(s). Upon determining that a detectable item is no longer detectable by the powered device, a computer model can evaluate the scanned data from the broadcasts and determine the “highest signal strength” along with other associated information such as the last recorded location of the detectable item, etc. This information can be shared to the cloud or central server as a “last known location” along with an accuracy value of the location. An accuracy value can be determined based on the distance and/or path of the powered device and the interval at which broadcasts are detected. In the simplified example of FIG. 2D, a powered device can be traveling at a rate of speed (V) (e.g., 5.4 m/s) along a path 246, which may be straight, curved, etc. The interval (I) (e.g., every 8 seconds) at which the detectable item broadcasts can allow the determination of the detectable item to within a distance (D=V×I) (e.g., assigning an accuracy value of approximately 43 meters). The above numeral examples are provided for illustration only and should not be limiting the disclosed embodiments. For example, the speed can be 3, 4, 6, etc. m/s, the interval every 5, 6, 9, etc. seconds, and the distance computed accordingly. The model can also allow for other shapes based on the location values of the moving powered device (e.g., the above example of approximately 43 meters could be along a curved path of the powered device). With the system's recordation of the path of the powered device (or in some instances even merely its speed), the probable location of the detectable item can be determined.

In some embodiments, the process 250 can include repeatedly generating the inventory over a period of time based on repeated acquisitions of the sensor data. For example, the inventory can be regenerated every minute, five minutes, 30 minutes, etc. The inventory can be monitored to determine whether the inventory meets a threshold condition for generating the alert and an alert can be generated when the threshold condition is met. In various embodiments, examples of thresholds for alerts can include the threshold condition being a time since last detected for an item in the expected inventory exceeding a maximum time since last detected. For example, alerting when an item expected to be detected has not been detected for more than five minutes, 15 minutes, one hour, two hours, etc. In other embodiments, the threshold condition can be a distance for an item in the expected inventory having a last known location exceeding a maximum distance from the powered device. For example, alerting when an item's last location is more than 100 meters, 500 meters, 1 km, etc. from the current location of powered device 110.

The present disclosure contemplates that the detection of lost items can occur at any time, in some embodiments, the detection can specifically take place at times when it may be advantageous to do so. For example, if the powered device is loaded onto a vehicle and driven away, the vehicle attaining a speed that would not be possible for the powered device itself can trigger a detection for lost items that may have been left behind. Specifically, the disclosed processes can include performing the comparing when the powered device crosses a speed threshold that is greater than a top speed of the powered device. Examples of top speeds of powered devices can vary and naturally vary depending on the type of device. A riding mower may, for example, have a top speed of 25 kph, and therefore if detected to be moving at 35 or 40 kph this can trigger a comparison. As another example, a handheld tool does not inherently have a top speed but, for example, can be taken by the system to be 5 kph (e.g., as held by a walking user). Similarly, if the handheld tool is detected to be moving in excess of this speed threshold, then this can trigger a comparison.

As with numerous embodiments disclosed herein, the present disclosure contemplates the disclosed processes can be performed with the assistance of machine learning technologies. For example, in some embodiments, process 250 can include inputting inventory sets of powered devices as training data to a machine learning model. The machine learning model can be trained to determine when an item is missing from an input inventory. The inventory can be put into the machine learning model, which can then determine that the alert should be generated.

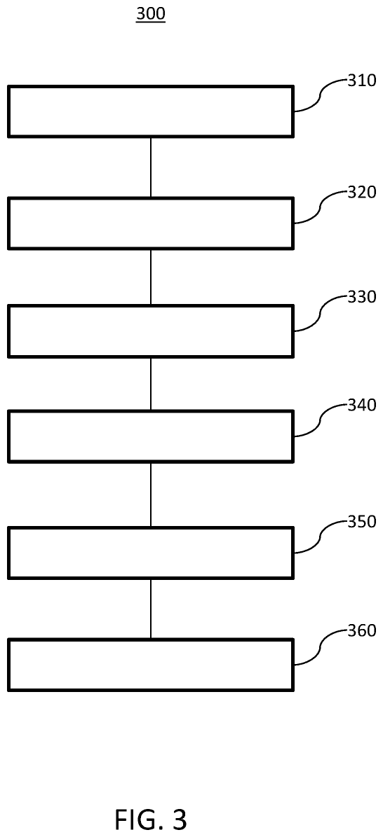

FIG. 3 illustrates a process flow for utilizing historical state data to generate alerts about a powered device in accordance with certain aspects of the present disclosure. While some embodiments can be based on current (or nearly current) sensor data about the powered device, other embodiments, such as the one depicted in FIG. 3, can utilize historical data to determine or predict aspects of the powered device. While the example below utilizes machine learning to facilitate determining/generating alerts, it is not essential that machine learning be utilized in any particular disclosed embodiment unless specifically stated.

At 310, process 300 can include receiving sensor data from sensors (such as battery sensor) operatively connected to a powered device.

At 320, process 300 can include determining a state based on the sensor data associated with one or more components of the powered device.

At 330, process 300 can include generating historical state data based on the state of the powered device over a period of time. This can include, for example, archiving sensor data from the powered device of interest and/or a collection of identical (or similar) powered devices. Examples of historical state data can include, for example, battery life, power consumption, time between component failures, operating temperature, location information, etc.

At 340, process 300 can include determining, based on the historical state data and the state of the powered device, that an alert needs to be generated for the powered device. Trends for the powered device 110 can be determined based on the archived sensor data. For example, if the powered device 110 has historically run out of power after approximately 10 hours of use, then the system could determine that an alert may be needed after nine or nine and a half hours of use. Similarly, historical state data from other powered devices of similar type can be utilized under the assumption that the current power device will have similar behavior. In some embodiments, historical state data can be analyzed to determine that an alert for maintenance is needed—before a component of the powered device 110 fails or requires servicing. In some embodiments, such as depicted in FIG. 3 and described with further reference to FIG. 4, the determination of the state of the powered device 110 (whether for generating alerts or for other possible states) can be enhanced by utilizing machine learning models. Such determinations can include predicting, with a machine learning model (such as machine learning model 230 illustrated in FIGS. 2A and 4) with the sensor data input into the machine learning model, that the alert needs to be generated, where the machine learning model can have been trained to predict the state of the powered device based on at least training data from a number of powered devices of the same (or similar) type as the powered device.

At 350, process 300 can include transmitting, to a client device (such as client device 140), state information about the powered device based at least on the state of the powered device.

At 360, process 300 can include generating the alert for transmission to the client device, where the alert can include one or more of a servicing recommended alert, a predicted component failure alert, etc. The alerts can be in the form of text, graphics, haptic, etc. The alert can also provide other useful information, for example, the location of a battery replacement facility, a recommended replacement battery, an estimated remaining operation time, etc. The alerts may be pushed to the client device through a notification and/or may be pulled by client device through an interface such as a webpage provided by the server 130 or service associated with the server 130.

FIG. 4 illustrates a simplified machine learning model in accordance with certain aspects of the present disclosure. FIG. 4 is a more detailed example of the optional machine learning model 230 running on server 130 as shown in FIG. 2A. In some embodiments, determining that the alert needs to be generated can include predicting, with machine learning model 230 and with the sensor data 210 input into the machine learning model, that the alert needs to be generated. In some embodiments, machine learning model 230 can be trained to predict the state of the powered device based on at least training data from a powered devices of the same (or similar) type as the powered device.

While many different types of machine learning models may be utilized, as one example, machine learning model 230 in FIG. 4 illustrates an example of an artificial neural network. Machine learning model 230 may include input layer 402 and may include one or more hidden layers (such as hidden layer 404 and hidden layer 406). Machine learning model 230 may be based on neural units (or artificial neurons). Each neural unit of machine learning model 230 may be connected with many other neural units of machine learning model 230. Such connections may be enforcing or inhibitory in their effect on the activation state of connected neural units. In some embodiments, each individual neural unit may have a summation function, which may combine the values of all of its inputs together. In some embodiments, each connection (or the neural unit itself) may have a threshold function such that the signal must surpass before it propagates to other neural units. Machine learning model 230 may be self-learning and trained, rather than explicitly programmed, and may perform significantly better in certain areas of problem solving, as compared to traditional computer programs. During training, output layer 408 may correspond to a prediction of a future value, and an input known to predict that value may be input into input layer 402. In some embodiments, machine learning model 230 may include multiple layers (such as where a signal path traverses from front layers to back layers). In some embodiments, back-propagation techniques may be utilized by machine learning model 230 where forward stimulation is used to reset weights on the “front” neural units.

In some embodiments, machine learning model 230 may be of other types, for example, LASSO, Random Forests, etc. In general, machine learning model 230 may take inputs such as sensor data 210 and provide outputs 232 (such as a status, alert, etc.). When training machine learning model 230, the inputs may include multiple data sets, such as a training data set and a test data set. In one use case, outputs 232 may be fed back to machine learning model 230 as input to train machine learning model 230 (such as alone or in conjunction with user indications of the accuracy of outputs 232, labels associated with the inputs, or with other reference feedback information). In another use case, machine learning model 230 may update its configurations (such as weights, biases, or other parameters) based on its assessment of its prediction (such as outputs 232) and reference feedback information (such as user indication of accuracy, reference labels, or other information). In another use case, where machine learning model 230 is a neural network, connection weights may be adjusted to reconcile differences between the neural network's prediction and the reference feedback. In a further use case, one or more neurons (or nodes) of the neural network may require that their respective errors are sent backward through the neural network to them to facilitate the update process (such as backpropagation of error). Updates to the connection weights may, for example, be reflective of the magnitude of error propagated backward after a forward pass has been completed. In this way, for example, the machine learning model 230 may be trained to generate better predictions.

The present disclosure contemplates that the technical improvements to obtaining sensor data, monitoring/analysis, and providing feedback (such as alerts, real-time status, etc.) can be applied to any type of powered device. However, below are descriptions of specific embodiments, none of which should be taken as limiting or excluding of any other embodiment as properly understood by a person of skill.

In some embodiments, the powered device 110 can be a riding mower, a stand-on mower, a zero-turn mower, a push mower or similar type lawn equipment, and the determined state can include rotations per minute (RPM) of a mower blade, with state information including changes in the RPM that indicate whether the powered device is mowing or not mowing. In other embodiments, the state can be a speed of the powered device, and the state information can include the speed and/or an alert of an excessive speed. Such data can be utilized to determine, for example, whether a mower is cutting or not cutting (such as running, but idle in place). In yet other embodiments, the state can be a location of the powered device, and the state information can include an indication of the location and/or an alert that the powered device is outside of a permissible location. In such embodiments, the system can be further configured to cause, responsive to the alert, the powered device to electronically and/or physically lock one or more components of the powered device to disable one or more operations of the powered device. For example, an electronic lock can include a software operation that can prevent movement, cutting, sensor data received/transmission, etc. Similarly, a physical lock can include causing a drivetrain, steering wheel, etc., to lock thereby rendering the powered device effectively inoperable. Other embodiments can include using sensor data from gyroscopes, accelerometers, or the like to determine that the state of a powered device rolled over or is at an otherwise unsafe position or orientation.

In some embodiments, historical state data can be generated from state data acquired and stored over time to include logged positional information (such as GPS coordinates over the last day, week, etc.) that can be made available to a user upon request. The determination and tracking of the locations of powered devices can also be utilized for configuring the system to have geofencing capabilities. For example, some embodiments can include determining geographical boundaries and providing alerts or controlling the powered device to perform other actions (such as disabling) when a geographical boundary is breached.

In other embodiments, GPS data can be utilized to provide driver-assist and/or turn-assist capabilities that minimize unnecessary overlap. For example, by knowing the size of a cutting width and a planned or executed route by a first mower, automated control commands can be generated for a second mower such that the second mower has little to no overlap with the area to be cut by the first mower. The automated control commands can be generated and transmitted in real time to the second mower based on real-time updates to the actual route of the first mower. Such control and route management can be monitored and updated in real time to account for changing battery status, unplanned starts/stops, schedule deviations, route deviations, failures (such as modifying fleet routes to account for a failed mower that cannot complete its route), etc. The automated control commands can be generated by a system configured to minimize one or more of a cutting time, battery usage, number of mowers needed, etc. The minimization algorithms can be based on historical data from actual powered devices and/or predicted data generated by a machine learning model (such as one providing predictions of battery use).

Other embodiments can include route planning, for example for vehicular powered devices such as automated or riding mowers. Route planning applications can be in systems configured to determine an optimal route that can account for remaining battery power and options/locations for battery charging and/or swapping. This can include, for example, generating a planned route that would place the powered device within range of a charging station, predefined start/end point for pickup, etc. when there is still some battery energy remaining (such as 5%, 10%, etc.).

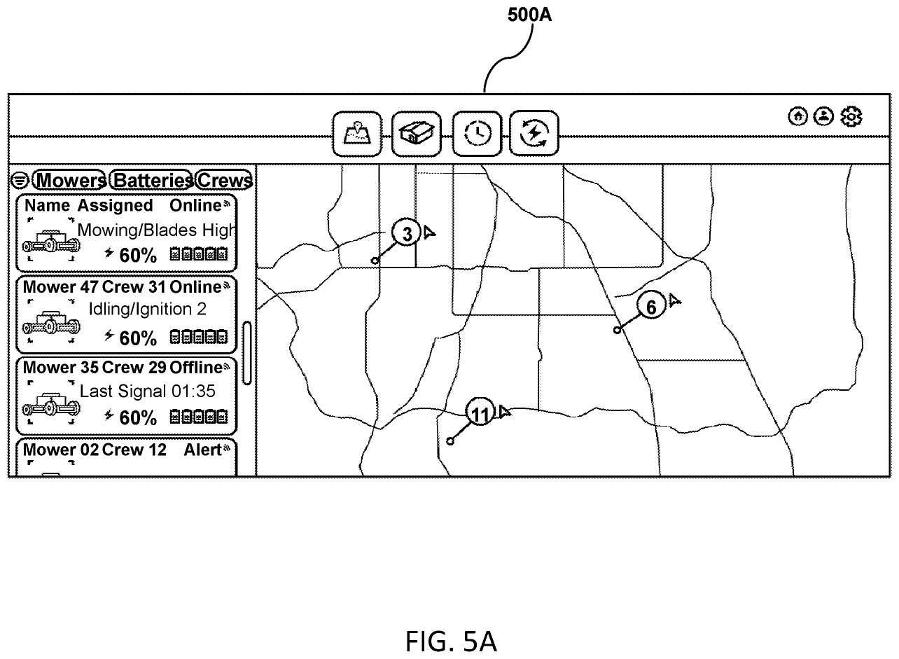

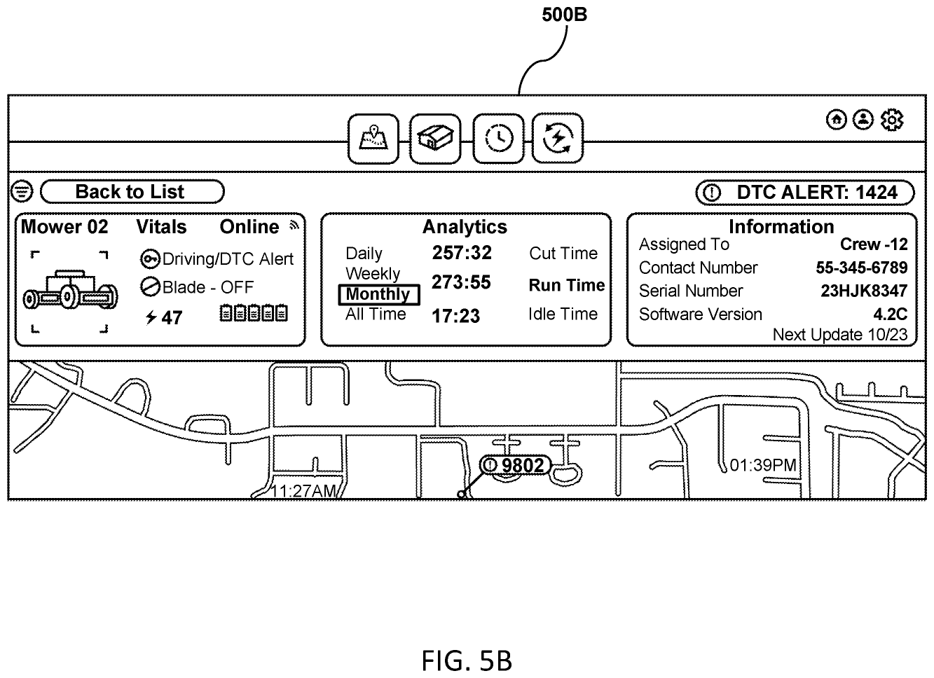

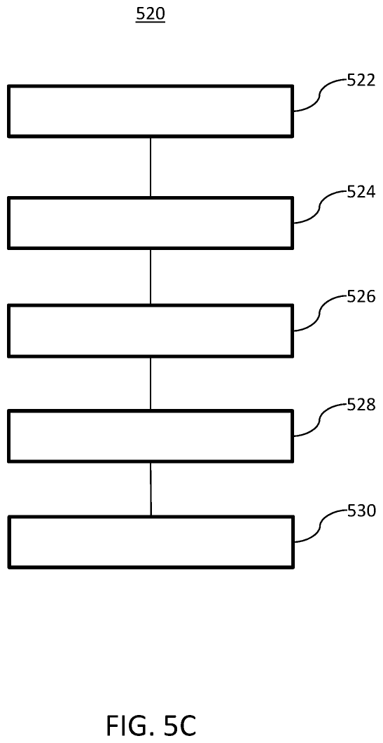

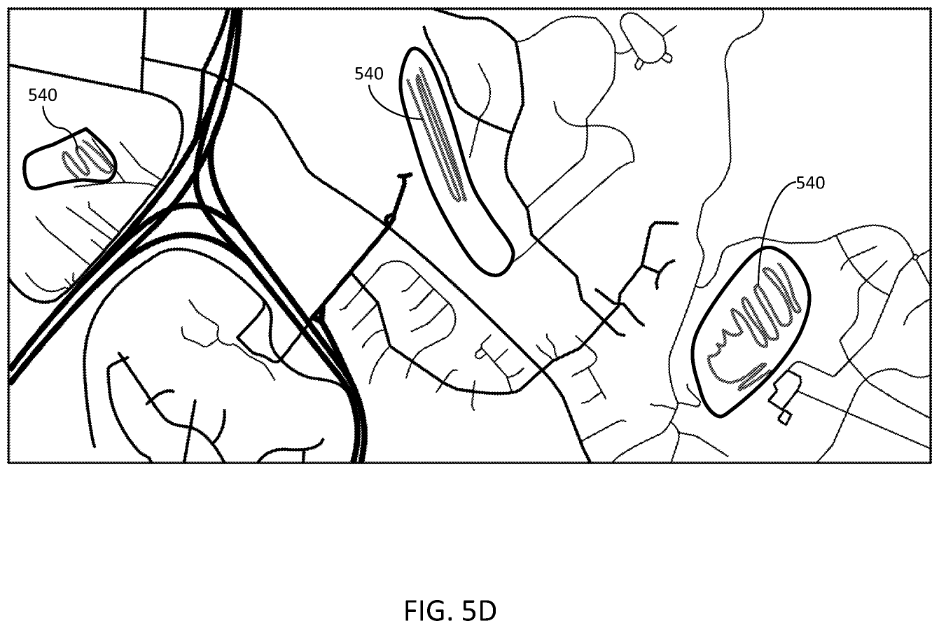

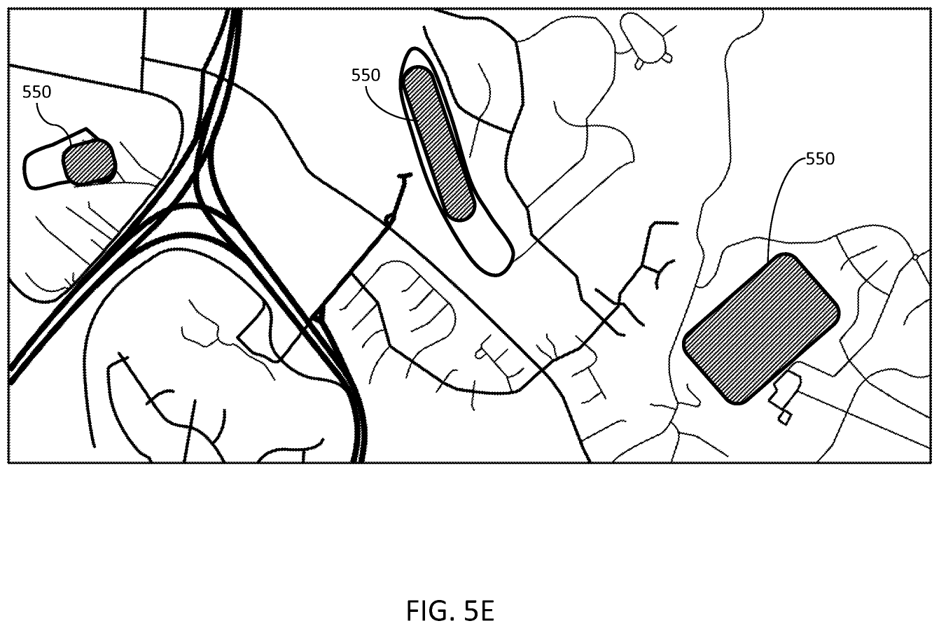

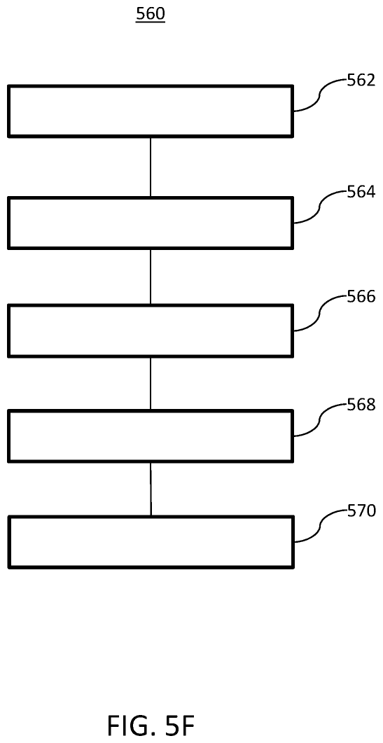

FIG. 5A illustrates an exemplary graphical user interface (GUI) 500A displaying locations and metrics of deployed powered devices in accordance with certain aspects of the present disclosure. As shown in FIG. 5A, GUI 500A includes a map interface that displays the locations of powered devices 110 (illustrated by numerals 3, 6, and 11) and a management interface that display various metrics such as an online indicator, a name/device identifier of the powered device, a battery charge, an operational state (such as “Mowing/Blades on High”), and/or other information known about and/or received from the powered device. Selection of a powered device in the map interface and/or the management interface may provide further details of the selected powered device, an example of which is shown in FIG. 5B.

FIG. 5B illustrates an exemplary graphical user interface (GUI) 500B displaying metrics indicative of a status of a powered device in accordance with certain aspects of the present disclosure. Some embodiments can include software configured to generate, for example, at the client device, a graphical user interface displaying metrics for the powered device. In some embodiments such as where the powered device is an electric mower or cutter, the metrics can include one or more of a run time, a battery charge, motor hours, power take off (PTO) hours, a cut-time, a location, etc. In some embodiments, the GUI can include the hours a powered device is on/off/idle/cutting, area mowed per unit time, average speed, etc.

An expanded list of metrics that may be included for a powered device such as an electric mower can include any combination of, current mower speed setting, current blade speed setting, mower on/off status, blade on/off status, charge status for each battery loaded in the mower, DTC code alert, current software version loaded on the mower, software upgrade indicator, current rider position—sit or stand, serial number for mower, crew the mower is assigned to, crew contact name, crew contact phone number, mower network status, etc.

Metrics that may be specifically associated with a battery may include a level of charge for the selected battery, charging state of the battery (fully charged, charging, current charge level), battery pack location status (onboard the mower or off board the mower), battery serial number, battery name, low battery alert, DTC alert for the battery, crew the battery is assigned to, crew contact name, crew contact phone number, last reported location (address and time/date stamp), etc.

In some embodiments, location data can be collected and shared from tool connect tags that may be attached to equipment such as trimmers, leaf blowers, etc. Such tool connect tags can have transceivers for active transmission, be passive and scannable at a job site, etc.

The disclosed metrics may permit highly detailed visibility into the historical and/or real-time status of one or more powered devices and can enable a large combination of features that may be present in any embodiment of the disclosed monitoring systems. Table 1 provides examples of such features.

TABLE 1
Description of Features

| Feature | Description |
|---|---|
| Real Time Mower Status | High level summary of selected real-time data for |
| | powered devices/equipment. |
| GPS Location | Built-in GPS providing real-time location of mowers |
| | and batteries for tracking, such as used for fleet |
| | overview and loss prevention. May include |
| | breadcrumb tracking historical activity. |
| Geofencing | Ability to set virtual, geographic boundaries such as for |
| | tracking of specific locations/customers |
| Productivity Dashboards | Information regarding productivity and usage of the |
| | powered device such as hours powered device is |
| | on/off/idle/cutting, square acres mowed per hour, |
| | average speed, etc. |
| Battery And Charging Data | Real time and historical data about the status of |
| | batteries and their charge status. |
| Custom Report Generation | Ability to create customized reports based on metrics, |
| | time period, mowers and/or crews of interest. |
| Alert Customization | Ability to customize alerts (e.g., alerts related to |
| | geofencing, safety, trouble codes, maintenance, custom |
| | reports) such as who gets certain alerts, alert frequency, |
| | delivery method (e.g., text, email), etc. |
| DTC Codes | A diagnostic trouble code (DTC) to diagnose |
| | malfunctions in equipment and identify what and |
| | where an issue is. |
| Preventative Maintenance | Planning of maintenance based on pre-defined intervals |
| | indicated by OEM schedule, notifications when it is |
| | due based on set intervals, visibility into maintenance |
| | history, etc. |
| Predictive Maintenance | Advanced notification with recommendation of |
| | maintenance required before part degradation or failure |
| | such as based on advanced analytics on historical |
| | operational data. |
| Parts & Accessories Ordering | Ability to manage subscriptions and purchase parts |
| | and/or accessories for this particular electric mower as |
| | well as other mowers/equipment associated with the brand. |
| Powered Device Health | Ability to share real-time data regarding powered |
| Sharing With Dealer | device warranty, status, and health such as active |
| | diagnostic trouble codes, maintenance schedule, GPS |
| | location, etc. to enable remote monitoring and for |
| | dealers to proactively reach out to service equipment. |
| Safety Alerts | Notifications when an unsafe event is detected, such as |
| | rollover or significant incline. |
| Remote Locking | Ability to lock the powered device from any place at |
| | any time. Locking may disable the power device from |
| | being turned on. |
| Cost Of Ownership Estimation | Outlines total cost associated with the powered device |
| | and compares to equivalent gas cost, cost estimate may |
| | include upfront cost of powered device, cost of battery |
| | and power, with parts and maintenance/repair costs |
| | being manually input. |
| CO₂ Avoidance Counter | Calculation of emissions avoided by using an electric |
| | powered device as opposed to a gas-powered device. |
| Access To Historical Data | Users will be able to access all data collected since |
| | powered device registration. |
| Third Party Integration | API integrations allowing visibility of data from the |
| | digital platform in a current business management and |
| | telematics platform (or the other way around). |
| EV Route Planning | Route planning and scheduling capability that |
| | considers remaining battery power and possibilities for |
| | charging/swapping batteries (either directly within the |
| | platform, or by integrating with other software). |
| Semi-autonomous Capability | Drive-assist and turn-assist capabilities (auto steer) |
| | such as using GPS-assisted driving to minimize |
| | unnecessary overlap and deliver more efficient cutting. |

FIG. 5C illustrates an exemplary process 520 for determining property and/or job locations in accordance with certain aspects of the present disclosure. For example, some embodiments of the present disclosure can facilitate determination of property locations where the powered device has been used. Such information can be, for example, organized in a database to provide current and/or historical information about where and how the powered device was used at particular properties and designate such uses as “jobs.”

As with other embodiments disclosed herein, a system can include a powered device in communication with computers configured to execute software to perform various disclosed processes for determining property and/or job locations.

At 522, process 520 can include receiving sensor data from sensors operatively connected to a powered device. Sensor data can include, for example, GPS data, power consumption by monitoring battery energy, accelerometer data, gyroscopic or inclinometer data, etc.

At 524, process 520 can include determining a state of the powered device based on the sensor data associated with one or more components of the powered device. Examples of states can include, as appropriate for the powered device, mowing or not mowing, moving or not moving, powered on or off, a speed/gear/mode of operation, a temperature, etc.

At 526, process 520 can include receiving, at a server, tracking data for the powered device. Tracking data can be, for example, sensor data such as GPS data, geofence breach locations, etc. Examples of tracking data 540 for a powered device are shown in FIG. 5D, in accordance with certain aspects of the present disclosure. FIG. 5D depicts an exemplary region with three locations where tracking data 540 for a powered device (or more than one powered device) can be obtained. As seen in FIG. 5D, each instance of tracking data does not necessarily fill the boundary of a property location. For example, tracking data 540 in the middle of FIG. 5D corresponds to mowing a portion, but not all of, a golf course. In this example, the acquisition of the tracking data can not only allow determination of the property location but can also facilitate determination of a job (e.g., mowing a particular section of the golf course rather than interpreting the entire golf course as being the job).

At 528, process 520 can include determining, at the server and based on the state and the tracking data, a property location where the powered device provided the tracking data and the sensor data. Continuing the example described above and shown in Figure the mowing can be determined to have been at a given address or coordinates by comparing with databases, public records, user-supplied data, etc. In some embodiments, repeated utilization of the powered device at the same general location can be utilized to create data points (e.g., GPS locations) that can be used to programmatically create estimated property boundaries. These estimated boundaries can be overlayed or compared with publicly available map data to draw logical synthetic property boundaries.

At 530, process 520 can include building a historical database based on the state and the tracking data. The historical database can associate the states of the powered device with the tracking data obtained at the time. Such a historical database can provide a comprehensive snapshot of what a powered device was doing at a particular location and can also provide data for training and/or predictive analysis with machine learning algorithms.

In some embodiments, repeated utilization of the powered device at the same general location can be utilized to create data points (e.g., including direction and attitude of headings, GPS locations, etc.) that can be used to programmatically create property attributes such as: % of hill/grade changes, % of non-mowed drive-only path/transport such as golf courses, % of grass density/type as certain grasses/locations grow faster, thicker, or thinner, etc. Such attributes, combined overlayed with publicly available map data will be used to create predictive analysis on power consumption, estimated time to complete a utilization, etc.

At 532, process 520 can include associating the state and the sensor data with the property location. Such associations can be established via the historical database, linking of objects or files in computer memory via identification codes or labels, etc.

In some embodiments, process 520 can include determining, based on the property location, a property address by utilizing a database that relates locations to property addresses. The property address can be obtained by queries from or comparisons with records such as databases that include relationships between a physical location and a recorded property address. The property address can then be returned in response to a query or other request for the property address by the system.

In some embodiments, process 520 can include determining a job designation that includes a specific occurrence of operation of the powered device at the property location. An example of a job designation is depicted in FIG. 5E where the job designation is illustrated by regions 550 that are seen to generally correspond with the tracking data 540. In other embodiments, process 520 can include determining a percent of completion of a current job based on comparison with the job designation. For example, tracking data can be compared with the job designation and, for example, if the tracking data indicates that only half of the physical extent of job designation has been completed, then the system can determine that current job is only 50% complete. Also, other embodiments can include performing calculations of energy saved or CO2 emissions avoided by the actual or intended use of the powered device for the job designation.

In some embodiments, process 520 can include generating a prompt for a user to confirm the designated job as a current job and, once confirmed, store the current job in computer memory. The prompt can be, for example, a graphical display only generated at a client device such as a smart phone or tablet being utilized by a user of the system.

In some embodiments, process 520 can include adding metadata to the job designation based on input from a user interface. Metadata can include, for example, annotations, flagging, dates and times, powered devices used, worker notes, customer notes, etc.

In some embodiments, process 520 can include utilizing machine learning to determine/update boundaries of property locations for one or more jobs. This can include, for example, inputting historical tracking data during use of powered devices at the property location as training data to a machine learning model. The machine learning model can be trained to determine a boundary of the property location. Tracking data can be input into the machine learning model, for example to update the boundary based on the most recent tracking data. The machine learning model can determine an updated boundary of the property location. For example, if the boundary of the property location at some time in the past had a certain size but the tracking data obtained during various jobs was repeatedly and significantly different than a previously determined boundary, then the machine learning model may provide an updated boundary of job correspond to the current accurate job boundary.

FIG. 5F illustrates an exemplary process 560 for determining a productivity metric in accordance with certain aspects of the present disclosure. Embodiments of the present subject matter can also facilitate determining and tracking productivity when using one or more of the disclosed powered devices. For example, a system can include a powered device and computer software configured to implement process 560. Process 560 can include, at 562, receiving sensor data from sensors operatively connected to a powered device. Sensor data can include, for example, data from blade sensors such as RPMs, vibrational data, load/resistance, etc.

Process 560 can include, at 562, receiving supplemental sensor data comprising information indirectly related to operation of the powered device. As used herein, the term “indirectly related” refers to sensor data that is reflective of utilization of the powered device beyond a determination of whether the powered device is being engaged for its most intended purpose. For example, a mower can be understood as having blades that cut grass, and when those blades are not spinning it would suggest the device is not being used (or not productive). However other supplemental sensor data, (e.g., accelerometer data indicating the device is moving—such as between mowing sites) can be utilized to determine or infer that the device is in fact being used productively. For example, knowing the mowing locations of the job, the system can allow for an expected amount of travel time or distance between locations on the jobsite and not penalize a determine productivity when the powered device has not exceeded the expected travel time/distance. Accordingly, the determination of productivity can be penalized less if the blades are off, but the mower is moving as compared to if the blades were on when the mower was moving. In such ways, supplemental sensor data (e.g., accelerometer, GPS, etc.) can be used by the disclosed systems and processes to improve the accuracy of determining productivity.

Process 560 can include, at 564, determining a state based on the sensor data associated with one or more components of the powered device (e.g., the state of a mower mowing or not mowing).

Process 560 can include, at 566, receiving a time of availability of the powered device (e.g., 1.0 man-hours). The time of availability can be entered by a user, determined based on a scheduled time of use such as one associated with a job designation, etc.

Process 560 can include, at 568, determining a time of use of the powered device based on the state of the powered device (e.g., 0.75 hours of mowing). The time of use can be determined based on the available sensor data and/or a time of use provided by a user.

Process 560 can include, at 570, generating, at the client device, a productivity metric based on the time of use, the supplemental sensor data, and the time of availability (e.g., productivity metric=(0.75 hours mowing+0.15 hours moving)/(1.0 hours of availability)=90%.

In some embodiments, process 560 can include comparing the productivity metric with a historical average productivity metric (e.g., as available from a database) and generate an alert at a client device when the productivity metric is below the historical average productivity metric.

In some embodiments, process 560 can include determining an electrical load of the powered device during the time of use, where the productivity metric can be further based on the electrical load. For example, utilizing the sensor data and/or the supplemental sensor data, the disclosed systems can determine, for example, that a mower running blades at full speed when being moved between mowing locations is likely wasting energy and therefore less productive. In some implementations, the powered device can be at least partially deactivated (e.g., run at a reduced rate or one or more components turned off, etc.) when the system determines that the powered device is not in a location where it should be used (e.g., turning off lawn mower blades when driving on pavement or gravel, a power tool turning off when outside a designated job boundary, etc.). Such features can be automatic but can optionally be enabled when the device is operated in a particular mode (e.g., “Eco-mode”) as set by a user or by the system. Such features can thereby reduce energy consumption of the powered device.

As with other embodiments herein, determining a productivity metric can be performed with the assistance of a machine learning model. For example, process 560 can also include inputting historical times of use of powered devices, historical times of availability of the powered devices, and historical productivity metrics as training data to a machine learning model. The machine learning model can be trained to determine the productivity metric (e.g., based on the historical times of use, historical times of availability, historical productivity metrics, etc.). With such a trained machine learning model, the time of use and the time of availability can be input into the machine learning model. The machine learning model can then determine the productivity metric.

The sensor data available from a powered device and its connectivity with servers or other computing systems that can analyze the sensor data can be utilized to allow the system to determine and/or predict what a sufficient amount of energy is expected to complete a job. Such implementations can be particularly useful for battery-powered devices, which may be utilized in widely varying locations and types/durations of jobs. However, with a sufficient body of historical knowledge, accurate predictions of needed battery energy can be made by the system and utilized to guide users in selecting the needed battery storage, providing accurate updates on the state of the devices energy relative to the expected job, etc.

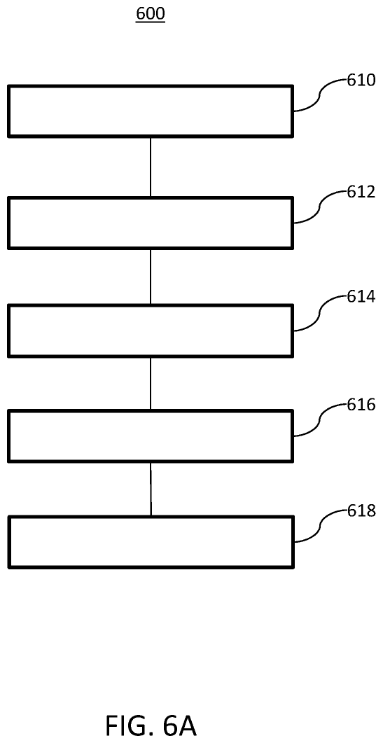

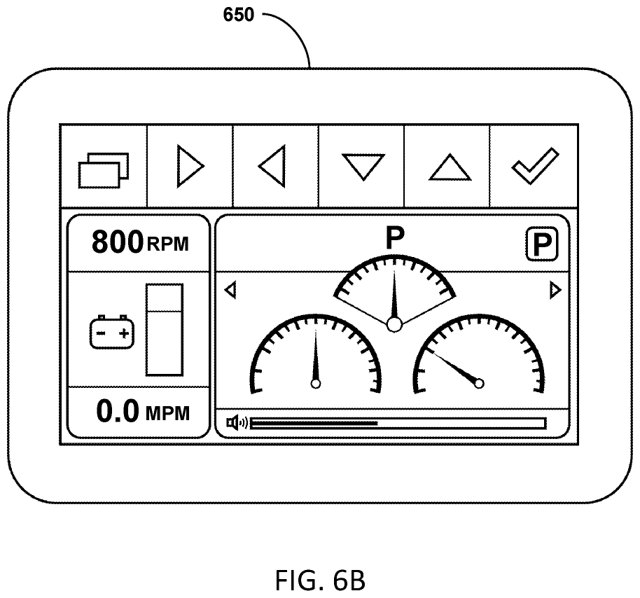

FIG. 6A illustrates an exemplary process 600 for determining a required amount of energy for a powered device in accordance with certain aspects of the present disclosure. One exemplary embodiment of such a system can include a powered device and software configured to perform process 600 for making the energy determination.

Process 600 can include, at 610, receiving sensor data from sensors operatively connected to a powered device. Examples of sensor data can include GPS location, time of use, power consumption, etc.

Process 600 can include, at 612, transmitting the sensor data to a server. Examples of servers can include cloud-based servers that can have additional processing power and/or memory for performing predictive analytics, executing machine learning models for predictions, etc.

Process 600 can include, at 614, building, at the server, a first historical database of energy requirements for the powered device. The first historical database can be a stand-alone database for the powered device of interest, can be included part of a larger database for numerous powered devices, etc. The first historical database, for example can include a record of how much energy the power device used during periods of usage, the rate of consumption of energy during usages, where and when the usage took place, and other sensor data or known data about the powered device that can have various degrees of correlation with the powered devices energy consumption, etc.

Process 600 can include, at 616, determining a required amount of energy for the powered device based on the first historical database and a second historical database containing past energy requirements for use of similar powered devices. For example, the accuracy of the determination can be improved by supplementing any available data about the power device with data from similar powered devices. As one example, while the first historical database may (or may not) have information about the power device mowing a particular lot area, the second historical database (e.g., which may be much larger include a large number of similar powered devices) can be utilized to provide or bolster the available data set under the assumption that similar mowers mowing similar lot sizes use similar amounts of energy. In other embodiments, the required amount of energy can be determined based on the second historical database without relying on a first historical database. For example, such can occur if the powered device of interest has never been used before (where the first historical database may not be available). Data in the historical databases can include, for example, an expected time of use (e.g., having a schedule of use for the next few days). Also, the determination can include updating (e.g., periodically or in an ongoing manner) a predictive model of energy requirements based on the available historical databases, updating the required amount of energy based on current conditions (e.g., knowing that it has rained or that the grass is wet in the morning can be accounted for in making a prediction of the required amount of energy).

Other information in the historical database can include determinations of local conditions such as precipitation, grass density (e.g., via analysis of mower blade resistance), etc. Publicly available environmental and historical information can be acquired, such as determining from trends or available analysis that: spring months generate thicker grass, in the summer the grass is thinner, rain in immediate history in a given location can increase in grass density and an increase power consumed or challenging traction or damage to grass/yard/field if attempted to mow.

Examples of historical data used from the powered device can include: duration of a previous mow, driving/mowing speed, efficiency settings for past utilizations at the same job or property. Information used from similar devices can be applied to determine CO2 savings. For example, if there is X amount of petrochemical fuel typically used in comparison to the powered device's use of Y Watt-hours, the system can then determine and report at a display device or stored in an electronic report that Z kilograms of CO2 were not introduced to the environment.

In some embodiments, the determination can also be based on seasonal or environmental factors. For example, if the average energy required over a year is lower than the energy required during the Spring (e.g., when grass may have grown faster and thicker due to rainfall), the determination for energy requirements during the Spring can include a factor based on this seasonal consideration. As another example of factors that can be utilized in the determination, geographical information (e.g., the specific location of use) can be taken into account. For example, there can be an average energy required over a large region such as a state or county, but the systems tracking of the powered device location could identify that it is in a hilly region and therefore upwardly adjust the required amount of energy.

Process 600 can include, at 618, receiving, at a client device, an indication representing the required amount of energy for the powered device. The indication can include a representation of a battery charge, an energy use rate, an energy remaining, a use time, a battery efficiency, etc. The indication can be an audio alert, visual alert on the screen, etc.

As previously described, a client device can be a user terminal such as a computer, smartphone, tablet, etc. A client device can also be a monitor or other display on the powered device itself such as a monitor or screen on the tool/mower.

In some embodiments, process 600 can also include determining, based on a battery inventory, whether an available amount of energy in the battery inventory is at least the required amount of energy. A notification can be generated at the client device when the available amount of energy is less than the required amount of energy.

Also, the required amount of energy can be further determined based on a proposed time of use of the powered device. For example, information entered by a user or obtained from a connected computing system can take a proposed/desired time of use and utilize the time of use in making the determining the required amount of energy. As one example, if it is determined that a powered device needs a certain amount of energy to perform a job but the entered proposed time of use is half of historically recorded kinds of use for that job, then the required amount of energy can be returned as being half as much.

Other embodiments can include those where the system accounts for current conditions of the powered device as well as analyzing its condition at some time in the past (e.g., the powered device's current energy storage and its rate of depletion that day in use). As such, process 600 can also include monitoring the state of the powered device over a period of time, determining a recommended change to the powered device based on the monitoring, and causing the recommended change to be displayed at the client device. Examples of recommended changes to the power device can be to recharge a battery, replace a battery, operate in a mode with a different energy consumption rate, etc.

In some embodiments, monitoring the state of the powered device can allow the system to predict when a powered device may fail due to energy depletion. For example, process 600 can include monitoring the state of the powered device over a period of time, determining a predicted failure mode of the powered device based on the monitoring, causing an alert indicative of the predicted failure mode to be displayed at the client device. In some examples, the predicted failure mode can be determined by a machine learning model utilizing the state of a battery of the powered device. In some embodiments, the disclosed processes can take into account the health of the battery and adjust the predicted battery capacity based on, for example, how many times the battery has been recharged, the age of the battery, etc. For example, there can be a lookup table that can include a number of recharges and can provide an expected battery capacity based on this number. Utilization of machine learning algorithms can also be implemented in making accurate predictions utilizing a large data set of data from similar batteries. For example, by having data on when similar batteries fail under various use conditions, age, type, etc., the predicted failure mode can be an end-of-life of the battery, and the alert can indicate the predicted failure mode and/or an estimated time for the end-of-life of the battery.

As with other embodiments herein, determining a productivity metric can be performed with the assistance of a machine learning model. For example, process 600 can also include inputting data from the second historical database as training data to a machine learning model and inputting properties where the similar powered devices were used. For example, providing past energy use of mowers at a given property location. The machine learning model can be trained to determine the required amount of energy utilizing the data that was input. A device identification for the powered device and a property identification can be input into the machine learning model. The machine learning model can determine the required amount of energy for the powered device at the property.

The information obtained from numerous powered devices over time can be leveraged to allow the system to determine or predict the behavior of similar powered devices. For example, some embodiments can include determining, for a second powered device (such as a new or replacement powered device), one or more of a predicted energy use rate, a maintenance estimate, CO2 emission reductions, etc. This determination can be based at least in part on the state determined at a prior time for the powered device (or many such similar powered devices). In some embodiments, CO2 emission reductions can be calculated based on the comparison of the current powered device to a similar device powered by fossil fuels.

Some embodiments of the systems disclosed herein can include those configured to anticipate the needs of a user with respect to selecting a proper type of powered device, a suitable energy source such as a battery based on the type of powered device and its expected use, etc. For example, as described in greater detail herein, a recommendation for a battery can be provided, as well as recommending changes to the battery based on usage of the powered device. In this way, the present disclosure facilitates, for example, the reduction of physical and electronic waste by providing recommendations for batteries optimized for the particular powered device and the anticipated use thereof.

In some embodiments, the system can determine, based on the state information from the powered device and from other powered devices, a recommended component of the powered device. For example, given a particular powered device such as an electric mower and the system's knowledge of how similar devices consume energy under similar conditions anticipated for the particular powered device, a recommended component such as a battery size, type, etc. can be determined. In other embodiments, the system can monitor the state of the powered device over a period of time and determine a recommended change to the powered device based on the monitoring. For example, by monitoring the rate of depletion of a battery and/or required power output during actual use, one example of a recommended change can be an increase or decrease in battery size. To facilitate interaction with a user, the system can cause the recommended change to be displayed at the client device.

In some embodiments, the system can be configured to determine a specific configuration of swappable batteries based on the known or predicted power needs. For example, a power device may be powered by a combination of swappable battery loads (such as 3 kWh batteries) that can be determined based on the run-time requirements.

In some embodiments, the system can predict when one or more components of the powered device may fail and alert a user (such as the powered device owner or a central monitoring station). In one exemplary embodiment, the system can monitor the state of the powered device over a period of time. The system can then determine a predicted failure mode of the powered device based on the monitoring. Examples of failure modes can include, for example, component breakage or need of replacement (such as a dull mower blade), battery depletion, etc. The system can also cause an alert indicative of the predicted failure mode to be displayed at the client device. Similar to other embodiments disclosed herein, the system can have the predicted failure mode determined by a machine learning model utilizing the state of a battery of the powered device. In some embodiments, the predicted failure mode can be an end-of-life of the battery, and the alert can indicate the predicted failure mode and/or an estimated time for the end-of-life of the battery.

FIG. 6B illustrates an exemplary graphical user interface displaying metrics of a battery for a powered device in accordance with certain aspects of the present disclosure. To facilitate interaction with a user, some embodiments can include generating, at the client device, a graphical user interface (GUI) 650 displaying metrics for the powered device. The metrics can include, for example, one or more of a battery charge, an energy use rate, an energy remaining, a use time, or a battery efficiency.

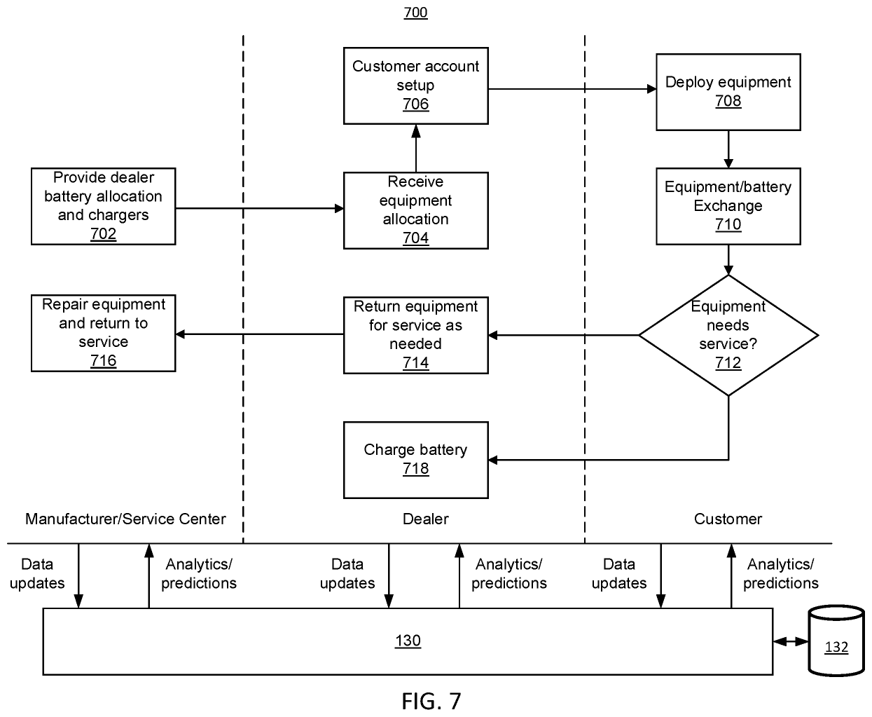

FIG. 7 illustrates a data flow diagram 700 of an example of a PaaS program and related metrics and analytics in accordance with certain aspects of the present disclosure. The data flow diagram 700 will refer to various components described herein, such as components in FIGS. 1, 2, and 4. For illustration, the data flow diagram 700 will be described with reference to providing batteries in connection with the PaaS program. However, other equipment may be provided. Furthermore, metrics and analysis may be provided relating to components and devices other than batteries.

The metrics and analytics may include the predictions, displays, and/or other functionality described herein. The various process blocks 702-718 may be performed by respective entities (or their computing systems), separated by dashed lines, as indicated in the data flow diagram 700. It should be noted, however, that the process blocks 702-718 may be performed by other entities.

Each process block may also be associated with providing data updates to the server 130 and/or receive analytics and/or predictions from the server 130. The server 130 may store data updates in the database 132. For example, data updates relating to the dealer may be stored in the dealer data structure of database 132, data updates relating to the customer may be stored in the customer data structure of database 132, and so forth. The server 130 may provide updated analytics and/or predictions to various entities in response to the updates. For example, the server 130 may provide updated predictions, analytics, and/or displays to the manufacturer or service center, the dealer, and/or the customer. In another example, the server 130 may periodically provide updated predictions, analytics, and/or displays periodically based on current data available in the database 132. Whether responsive to updates or periodically at intervals, the server 130 may retrain one or more machine-learning models 230 based on current data and provide new predictions or analytics based on the current data. In this manner, the one or more machine-learning models 230 may be updated based on monitored data of powered devices 110, implementation of the PaaS program, and/or other data accessible to the server 130.

At 702, the manufacturer and/or service center may provide a dealer battery allocation and chargers for dealers in connection with the PaaS program. The dealer battery allocation may be based on dealer demand, dealer capacity (including space and storage capacity), and/or other factors. Batteries in the dealer battery allocation may be used to provide to customers, used as demonstrators, and/or for calibration. Each of the batteries and other equipment may be identified by a battery identifier. When the dealer battery allocation is made, the server 130 may be notified and update the database 132 to indicate such allocation. For example, the server 130 may cause a link between a dealer identifier and a battery identifier to be stored. Such stored link may indicate that the dealer has been allocated with the battery in connection with the PaaS program.

At 704, the dealer may receive the dealer battery allocation. The dealer may add the batteries in the dealer battery allocation to its local dealer inventory of batteries.

At 706, the dealer may set up a customer account for participation in the PaaS program. Doing so may generate a customer account identifier that identifies the customer account and indicates that the customer account is subscribed to participate in the PaaS program. The customer account may be associated billing, battery tracking, and/or other customer related data. The customer account identifier may be stored in the database 132 so that the server 130 may monitor batteries provided to customers in connection with the PaaS program. The dealer may provide an initial customer battery allocation to the customer. The initial customer battery allocation may be based on predictive analytics by one or more machine learning models 230. For example, a machine learning model 230 may predict a number of batteries, capacity of batteries, and/or other requirements of a customer so that the customer may be provided with an appropriate number and/or capacity of batteries.

To provide the customer with its customer battery allocation, the dealer input corresponding battery identifiers for linking with the customer account identifier. For example, each battery may include an encoding such as a barcode, Quick Response code, or other encoding that the dealer may scan with a scanning device. Alternatively, the dealer may key-in the battery identifier, which may be printed, embossed, or otherwise placed on each battery. The server 130 may be updated with data indicating the customer battery allocation. For example, the server 130 may link the customer account identifier of the customer with battery identifiers that were provided in the customer battery allocation. Such battery identifiers may be part of the dealer battery allocation since the dealer provided the customer with the batteries from its dealer battery allocation.

At 708, the customer may deploy, within powered devices 110, one or more of the batteries from its initial customer battery allocation. For example, the one or more batteries may be used by landscapers on mower devices deployed in the field. While deployed, the mower devices (or other powered devices 110) may provide sensor data and/or other data such as DTCs to the server 130. Responsive to the updated data, or periodically at intervals, the server 130 may provide updated analytics relating to the sensor data and/or other data. For example, the server 130 may perform predictive analytics using one or more machine learning models 230 to predict whether a deployed battery will fail and therefore requires preventative maintenance or should otherwise be taken out of circulation for repair or end-of-life.

At 710, the customer may return one or more of the batteries to the dealer for swapping with a fully charged battery. Such return may be made in person or via mail. For example, after using a battery, the customer may return the used battery to the dealer for swapping with a charged battery.

At 712, the dealer may exchange the used battery with a charged battery under the PaaS program and determine whether the used battery requires service. For example, the dealer may scan or otherwise input the battery identifier of the used battery to indicate that the used battery is being returned and then scan or input the battery identifier of a charged battery to indicate that the charged battery is replacing the used battery. The dealer may determine whether the used battery requires service at the time of return and/or the server 130 may have already determined that the battery requires service and has flagged the battery for such service. For example, the server 130 may store the battery identifier in association with an indication that the battery requires service or will otherwise fail. Whether previously flagged for service or determined at the time of return, at 716, the dealer may return the battery for service. At 718, the manufacturer and/or service center may service the battery and return the serviced battery into a pool of available batteries for allocation to a dealer.

If the used battery does not require service, at 714, the dealer may charge the used battery and add the charged battery into a pool of available dealer batteries to swap with a used battery.

In the following, further features, characteristics, and exemplary technical solutions of the present disclosure will be described in terms of items that may be optionally claimed in any combination:

Item 1: A non-transitory machine-readable medium storing instructions which, when executed by at least one programmable processor, cause the at least one programmable processor to: receive sensor data from sensors operatively connected to a powered device; determine a state based on the sensor data associated with one or more components of the powered device; and generate historical state data based on the state of the powered device over a period of time; determine, based on the historical state data and the state of the powered device, that an alert needs to be generated for the powered device, the determining comprising predicting, with a machine learning model with the sensor data input into the machine learning model, that the alert needs to be generated, wherein the machine learning model has been trained to predict the state of the powered device based on at least training data from a plurality of powered devices of the same type as the powered device; transmit, to a client device, state information about the powered device based at least on the state of the powered device; and generate the alert for transmission to the client device, wherein the alert is one or more of a servicing recommended alert, or a predicted component failure alert.

Item 2: A non-transitory machine-readable medium storing instructions which, when executed by at least one programmable processor, cause the at least one programmable processor to: receive sensor data from sensors operatively connected to a powered device; determine a state based on the sensor data associated with one or more components of the powered device; and transmit, to a client device, state information about the powered device based at least on the state of the powered device.

Item 3: The machine-readable medium of any of the preceding items, wherein the powered device is a mower.

Item 4: The machine-readable medium of any of the preceding items, wherein the powered device is a power drill, a handheld mower, or an electric saw.

Item 5: The machine-readable medium of any of the preceding items, wherein the one or more components comprises at least one of: a battery, a drive train, a suspension system, or a positional system.

Item 6: The machine-readable medium of any of the preceding items, wherein the instructions, when executed, further cause the at least one programmable processor to: automatically collect the sensor data from the one or more sensors of the powered device; and automatically transmit the sensor data to a server monitoring the powered device.

Item 7: The machine-readable medium of any of the preceding items, wherein the sensor data is received from a plurality of powered devices associated with one or more users, wherein the instructions, when executed, further cause the at least one programmable processor to: monitor states of the plurality of powered devices each having at least one battery; and transmit, to the client device, state information for the at least one battery.

Item 8: The machine-readable medium of any of the preceding items, wherein the state information for the at least one battery includes one or more of: energy remaining, time of use remaining, and available power output.

Item 9: The machine-readable medium of any of the preceding items, wherein the instructions, when executed, further cause the at least one programmable processor to: determine, based on the state, that an alert needs to be generated for the powered device; generate the alert at the client device, wherein the alert is one or more of an online/offline alert, a missing alert, a servicing needed alert, or a component failure alert.

Item 10: The machine-readable medium of any of the preceding items, wherein the instructions, when executed, further cause the at least one programmable processor to: generate historical state data based on the state of the powered device over a period of time; determine, based on the historical state data and the state of the powered device, that an alert needs to be generated for the powered device; and generate the alert at the client device, wherein the alert is one or more of a servicing recommended alert, or a predicted component failure alert.

Item 11: The machine-readable medium of any of the preceding items, wherein to determine that the alert needs to be generated, the at least one programmable processor is further caused to predict, with a machine learning model with the sensor data input into the machine learning model, that the alert needs to be generated, wherein the machine learning model has been trained to predict the state of the powered device based on at least training data from a plurality of powered devices of the same type as the powered device.

Item 12: The machine-readable medium of any of the preceding items, wherein the state includes a rotations per minute (RPM) of a mower blade, and the state information includes changes in the RPM that indicate whether the powered device is mowing or not mowing.

Item 13: The machine-readable medium of any of the preceding items, wherein the state is a speed of the powered device, and the state information includes the speed and/or an alert of an excessive speed.

Item 14: The machine-readable medium of any of the preceding items, wherein the state is a location of the powered device, and the state information includes an indication of the location and/or an alert that the powered device is outside of a permissible location.

Item 15: The machine-readable medium of any of the preceding items, wherein the instructions, when executed, further cause the at least one programmable processor to cause, responsive to the alert, the powered device to electronically and/or physically lock one or more components of the powered device to disable one or more operations of the powered device.

Item 16: The machine-readable medium of any of the preceding items, wherein the instructions, when executed, further cause the at least one programmable processor to generate, at the client device, a graphical user interface (GUI) displaying metrics for the powered device.

Item 17: The machine-readable medium of any of the preceding items, the metrics comprising one or more of a run time, a battery charge, motor hours, power take off (PTO) hours, a cut-time, or a location.

Item 18: The machine-readable medium of any of the preceding items, wherein the instructions, when executed, further cause the at least one programmable processor to determine, for a second powered device, one or more of a predicted energy use rate, a maintenance estimate, or CO2 emission reductions, the determining based at least in part on the state determined at a prior time for the powered device.

Item 19: The machine-readable medium of any of the preceding items, wherein the instructions, when executed, further cause the at least one programmable processor to determine, based on the state information from the powered device and from other powered devices, a recommended component of the powered device.

Item 20: The machine-readable medium of any of the preceding items, wherein the instructions, when executed, further cause the at least one programmable processor to: monitor the state of the powered device over a period of time; determine a recommended change to the powered device based on the monitoring; and cause the recommended change to be displayed at the client device.

Item 21: The machine-readable medium of any of the preceding items, wherein the instructions, when executed, further cause the at least one programmable processor to: monitor the state of the powered device over a period of time; determine a predicted failure mode of the powered device based on the monitoring; and cause an alert indicative of the predicted failure mode to be displayed at the client device.

Item 22: The machine-readable medium of any of the preceding items, wherein the predicted failure mode is determined by a machine learning model utilizing the state of a battery of the powered device.

Item 23: The machine-readable medium of any of the preceding items, wherein the predicted failure mode is an end-of-life of the battery, and the alert indicates the predicted failure mode and/or an estimated time for the end-of-life of the battery.

Item 24: The machine-readable medium of any of the preceding items, wherein the instructions, when executed, further cause the at least one programmable processor to generate, at the client device, a graphical user interface (GUI) displaying metrics for the powered device.

Item 25: The machine-readable medium of any of the preceding items, the metrics comprising one or more of a battery charge, an energy use rate, an energy remaining, a use time, or a battery efficiency.

Item 26: A system, comprising: a database comprising: a customer data structure having one or more customer data fields that are structured to store customer account identifiers, each customer account identifier uniquely identifying a customer account that is subscribed to participate in a power as a service (PaaS) program in which batteries for electric tools are exchangeable on a subscription basis; a battery data structure having one or more battery data fields that are structured to store battery identifiers that each uniquely identify a battery that is to be exchanged in connection with the PaaS program; and a provider data structure having one or more provider data fields that are structured to store provider identifiers that each uniquely identify a provider that is to exchange batteries in connection with the PaaS program; and at least one processor programmed to: receive an indication that a provider has been provided with a provider allotment comprising a plurality of batteries for exchanging batteries in connection with the PaaS program, wherein the plurality of batteries are each identified by a respective battery identifier; store a link between each of the battery identifiers and a provider identifier that identifies the provider to track the provider allotment; receive an indication that an initial customer allotment of batteries has been provided by the provider to a customer in connection with the PaaS program, the initial customer allotment being allotted from the provider allotment; link a first set of battery identifiers that each identify a battery from the initial customer allotment with a customer account identifier that identifies the customer and an indication, for each of the first set of battery identifiers, that a corresponding battery has been provided to the customer in connection with the PaaS program; receive an indication that the provider exchanged, with the customer, a first battery in the initial customer allotment with a second battery in the provider allotment; link a second battery identifier identifying the second battery with the customer account identifier to indicate that the second battery has been provided to the customer in connection with the PaaS program; and store an indication that the first battery has been returned to the provider.

Item 27: A system comprising: a powered device; at least one programmable processor; and a non-transitory machine-readable medium storing instructions which, when executed by the at least one programmable processor, cause the at least one programmable processor to: receive sensor data from sensors operatively connected to a powered device; generate, based on the sensor data, an inventory of detectable items proximate the powered device; compare the inventory of detectable items to an expected inventory of detectable items that are expected to be proximate the powered device; and generate an alert at a client device when the inventory of detectable items does not match the expected inventory of detectable items.

Item 28: The system as in any one of the preceding Items, wherein the powered device is a battery-operated outdoor device.

Item 29: The system as in any one of the preceding Items, wherein the powered device is a mower.

Item 30: The system as in any one of the preceding Items, wherein the powered device is a power drill, a handheld mower, or an electric saw.

Item 31: The system as in any one of the preceding Items, wherein the instructions, when executed, further cause the at least one programmable processor to: generate, at the client device, a last known location of an item from the expected inventory that is not in inventory.

Item 32: The system as in any one of the preceding Items, wherein the instructions, when executed, further cause the at least one programmable processor to: repeatedly generate the inventory over a period of time based on repeated acquisitions of the sensor data; monitor the inventory to determine whether the inventory meets a threshold condition for generating the alert; and generate the alert when the threshold condition is met.

Item 33: The system as in any one of the preceding Items, wherein the threshold condition is a time since last detected for an item in the expected inventory exceeding a maximum time since last detected.

Item 34: The system as in any one of the preceding Items, wherein the threshold condition is a distance for an item in the expected inventory having a last known location exceeding a maximum distance from the powered device.

Item 35: The system as in any one of the preceding Items, wherein the instructions, when executed, further cause the at least one programmable processor to: perform the comparing when the powered device crosses a speed threshold that is greater than a top speed of the powered device.

Item 36: The system as in any one of the preceding Items, wherein the instructions, when executed, further cause the at least one programmable processor to: input inventory sets of powered devices as training data to a machine learning model; train the machine learning model to determine when an item is missing from an input inventory; input the inventory into the machine learning model; and determine, with the machine learning model, that the alert should be generated.

Item 37: A non-transitory machine-readable medium storing instructions which, when executed by at least one programmable processor, cause the at least one programmable processor to: receive sensor data from sensors operatively connected to a powered device; generate, based on the sensor data, an inventory of detectable items proximate the powered device; compare the inventory of detectable items to an expected inventory of detectable items that are expected to be proximate the powered device; and generate an alert at a client device when the inventory of detectable items does not match the expected inventory of detectable items.

Item 38: The machine-readable medium as in any one of the preceding Items, wherein the instructions, when executed, further cause the at least one programmable processor to: generate, at the client device, a last known location of an item from the expected inventory that is not in inventory.

Item 39: The machine-readable medium as in any one of the preceding Items, wherein the instructions, when executed, further cause the at least one programmable processor to: repeatedly generate the inventory over a period of time based on repeated acquisitions of the sensor data; monitor the inventory to determine whether the inventory meets a threshold condition for generating the alert; and generate the alert when the threshold condition is met.

Item 40: The machine-readable medium as in any one of the preceding Items, wherein the threshold condition is a time since last detected for an item in the expected inventory exceeding a maximum time since last detected.

Item 41: The machine-readable medium as in any one of the preceding Items, wherein the threshold condition is a distance for an item in the expected inventory having a last known location exceeding a maximum distance from the powered device.

Item 42: The machine-readable medium as in any one of the preceding Items, wherein the instructions, when executed, further cause the at least one programmable processor to: perform the comparing when the powered device crosses a speed threshold that is greater than a top speed of the powered device.

Item 43: The machine-readable medium as in any one of the preceding Items, wherein the instructions, when executed, further cause the at least one programmable processor to: input inventory sets of powered devices as training data to a machine learning model; train the machine learning model to determine when an item is missing from an input inventory; input the inventory into the machine learning model; and determine, with the machine learning model, that the alert should be generated.

Item 44: A computer implemented method causing at least one programmable processor to perform operations comprising: receive sensor data from sensors operatively connected to a powered device; generate, based on the sensor data, an inventory of detectable items proximate the powered device; compare the inventory of detectable items to an expected inventory of detectable items that are expected to be proximate the powered device; and generate an alert at a client device when the inventory of detectable items does not match the expected inventory of detectable items.

Item 45: The method as in any one of the preceding Items, wherein the operations, when executed, further cause the at least one programmable processor to: generate, at the client device, a last known location of an item from the expected inventory that is not in inventory.

Item 46: The method as in any one of the preceding Items, wherein the operations, when executed, further cause the at least one programmable processor to: repeatedly generate the inventory over a period of time based on repeated acquisitions of the sensor data; monitor the inventory to determine whether the inventory meets a threshold condition for generating the alert; and generate the alert when the threshold condition is met.

Item 47: The method as in any one of the preceding Items, wherein the threshold condition is a time since last detected for an item in the expected inventory exceeding a maximum time since last detected.

Item 48: The method as in any one of the preceding Items, wherein the threshold condition is a distance for an item in the expected inventory having a last known location exceeding a maximum distance from the powered device.

Item 49: The method as in any one of the preceding Items, wherein the operations, when executed, further cause the at least one programmable processor to: perform the comparing when the powered device crosses a speed threshold that is greater than a top speed of the powered device.

Item 50: The method as in any one of the preceding Items, wherein the operations, when executed, further cause the at least one programmable processor to: input inventory sets of powered devices as training data to a machine learning model; train the machine learning model to determine when an item is missing from an input inventory; input the inventory into the machine learning model; and determine, with the machine learning model, that the alert should be generated.

Item 51: A system comprising: a powered device; at least one programmable processor; and a non-transitory machine-readable medium storing instructions which, when executed by the at least one programmable processor, cause the at least one programmable processor to: receive sensor data from sensors operatively connected to a powered device; and transmit the sensor data to a server; build, at the server, a first historical database of energy requirements for the powered device; determine a required amount of energy for the powered device based on the first historical database and a second historical database containing past energy requirements for use of similar powered devices; and receive, at a client device, an indication representing the required amount of energy for the powered device.

Item 52: The system as in any one of the preceding Items, wherein the powered device is a battery-operated outdoor device.

Item 53: The system as in any one of the preceding Items, wherein the battery-operated outdoor device is a mower.

Item 54: The system as in any one of the preceding Items, wherein the powered device is a handheld tool.

Item 55: The system as in any one of the preceding Items, wherein the handheld tool is a power drill, a handheld mower, or an electric saw.

Item 56: The system as in any one of the preceding Items, wherein the instructions, when executed, further cause the at least one programmable processor to: determine, based on a battery inventory, whether an available amount of energy in the battery inventory is at least the required amount of energy; and generating a notification at the client device when the available amount of energy is less than the required amount of energy.

Item 57: The system as in any one of the preceding Items, wherein the required amount of energy is further determined based on a proposed time of use of the powered device.

Item 58: The system as in any one of the preceding Items, wherein the instructions, when executed, further cause the at least one programmable processor to: monitor a state of the powered device over a period of time; determine a recommended change to the powered device based on the monitoring; and cause the recommended change to be displayed at the client device.

Item 59: The system as in any one of the preceding Items, wherein the instructions, when executed, further cause the at least one programmable processor to: monitor a state of the powered device over a period of time; determine a predicted failure mode of the powered device based on the monitoring; and cause an alert indicative of the predicted failure mode to be displayed at the client device.

Item 60: The system as in any one of the preceding Items, wherein the predicted failure mode is determined by a machine learning model utilizing the state of a battery of the powered device.

Item 61: The system as in any one of the preceding Items, wherein the predicted failure mode is an end-of-life of the battery, and the alert indicates the predicted failure mode and/or an estimated time for the end-of-life of the battery.

Item 62: The system as in any one of the preceding Items, wherein the indication also includes a representation of a battery charge, an energy use rate, an energy remaining, a use time, or a battery efficiency.

Item 63: The system as in any one of the preceding Items, wherein the instructions, when executed, further cause the at least one programmable processor to: input data from the second historical database as training data to a machine learning model and properties where the similar powered devices were used; train the machine learning model to determine the required amount of energy; input a device identification for the powered device and a property identification into the machine learning model; and determine, with the machine learning model, the required amount of energy for the powered device at the property.

Item 64: A non-transitory machine-readable medium storing instructions which, when executed by at least one programmable processor, cause the at least one programmable processor to: receive sensor data from sensors operatively connected to a powered device; and transmit the sensor data to a server; build, at the server, a first historical database of energy requirements for the powered device; determine a required amount of energy for the powered device based on the first historical database and a second historical database containing past energy requirements for use of similar powered devices; and receive, at a client device, an indication representing the required amount of energy for the powered device.

Item 65: The machine-readable medium as in any one of the preceding Items, wherein the instructions, when executed, further cause the at least one programmable processor to: determine, based on a battery inventory, whether an available amount of energy in the battery inventory is at least the required amount of energy; and generating a notification at the client device when the available amount of energy is less than the required amount of energy.

Item 66: The machine-readable medium as in any one of the preceding Items, wherein the required amount of energy is further determined based on a proposed time of use of the powered device.

Item 67: The machine-readable medium as in any one of the preceding Items, wherein the instructions, when executed, further cause the at least one programmable processor to: monitor a state of the powered device over a period of time; determine a recommended change to the powered device based on the monitoring; and cause the recommended change to be displayed at the client device.

Item 68: The machine-readable medium as in any one of the preceding Items, wherein the instructions, when executed, further cause the at least one programmable processor to: monitor a state of the powered device over a period of time; determine a predicted failure mode of the powered device based on the monitoring; and cause an alert indicative of the predicted failure mode to be displayed at the client device.

Item 69: The machine-readable medium as in any one of the preceding Items, wherein the predicted failure mode is determined by a machine learning model utilizing the state of a battery of the powered device.

Item 70: The machine-readable medium as in any one of the preceding Items, wherein the predicted failure mode is an end-of-life of the battery, and the alert indicates the predicted failure mode and/or an estimated time for the end-of-life of the battery.

Item 71: The machine-readable medium as in any one of the preceding Items, wherein the indication also includes a representation of a battery charge, an energy use rate, an energy remaining, a use time, or a battery efficiency.

Item 72: The machine-readable medium as in any one of the preceding Items, wherein the instructions, when executed, further cause the at least one programmable processor to: input data from the second historical database as training data to a machine learning model and properties where the similar powered devices were used; train the machine learning model to determine the required amount of energy; input a device identification for the powered device and a property identification into the machine learning model; and determine, with the machine learning model, the required amount of energy for the powered device at the property.

Item 73: A computer implemented method causing at least one programmable processor to perform operations comprising: receive sensor data from sensors operatively connected to a powered device; and transmit the sensor data to a server; build, at the server, a first historical database of energy requirements for the powered device;

determine a required amount of energy for the powered device based on the first historical database and a second historical database containing past energy requirements for use of similar powered devices; and receive, at a client device, an indication representing the required amount of energy for the powered device.

Item 74: The method as in any one of the preceding Items, wherein the operations, when executed, further cause the at least one programmable processor to: determine, based on a battery inventory, whether an available amount of energy in the battery inventory is at least the required amount of energy; and generating a notification at the client device when the available amount of energy is less than the required amount of energy.

Item 75: The method as in any one of the preceding Items, wherein the required amount of energy is further determined based on a proposed time of use of the powered device.

Item 76: The method as in any one of the preceding Items, wherein the operations, when executed, further cause the at least one programmable processor to: monitor a state of the powered device over a period of time; determine a recommended change to the powered device based on the monitoring; and cause the recommended change to be displayed at the client device.

Item 77: The method as in any one of the preceding Items, wherein the operations, when executed, further cause the at least one programmable processor to: monitor a state of the powered device over a period of time; determine a predicted failure mode of the powered device based on the monitoring; and cause an alert indicative of the predicted failure mode to be displayed at the client device.

Item 78: The method as in any one of the preceding Items, wherein the predicted failure mode is determined by a machine learning model utilizing the state of a battery of the powered device.

Item 79: The method as in any one of the preceding Items, wherein the predicted failure mode is an end-of-life of the battery, and the alert indicates the predicted failure mode and/or an estimated time for the end-of-life of the battery.

Item 80: The method as in any one of the preceding Items, wherein the indication also includes a representation of a battery charge, an energy use rate, an energy remaining, a use time, or a battery efficiency.

Item 81: The method as in any one of the preceding Items, wherein the operations, when executed, further cause the at least one programmable processor to: input data from the second historical database as training data to a machine learning model and properties where the similar powered devices were used; train the machine learning model to determine the required amount of energy; input a device identification for the powered device and a property identification into the machine learning model; and determine, with the machine learning model, the required amount of energy for the powered device at the property.

Item 82: A system comprising: a powered device; at least one programmable processor; and a non-transitory machine-readable medium storing instructions which, when executed by the at least one programmable processor, cause the at least one programmable processor to: receive sensor data from sensors operatively connected to a powered device; determine a state of the powered device based on the sensor data associated with one or more components of the powered device; receive, at a server, tracking data for the powered device; and determine, at the server and based on the state and the tracking data, a property location where the powered device provided the tracking data and the sensor data; build a historical database based on the state and the tracking data; and associate the state and sensor data with the property location.

Item 83: The system as in any one of the preceding Items, wherein the powered device is a battery-operated outdoor device.

Item 84: The system as in any one of the preceding Items, wherein the powered device is a mower.

Item 85: The system as in any one of the preceding Items, wherein the powered device is a power drill, a handheld mower, or an electric saw.

Item 86: The system as in any one of the preceding Items, wherein the instructions, when executed, further cause the at least one programmable processor to determine, based on the property location, a property address by utilizing a database that relates locations to property addresses.

Item 87: The system as in any one of the preceding Items, wherein the instructions, when executed, further cause the at least one programmable processor to determine a job designation comprising a specific occurrence of operation of the powered device at the property location.

Item 88: The system as in any one of the preceding Items, wherein the instructions, when executed, further cause the at least one programmable processor to determine a percent of completion of a current job based on comparison with the job designation.

Item 89: The system as in any one of the preceding Items, wherein the instructions, when executed, further cause the at least one programmable processor to generate a prompt for a user to confirm the job designation as a current job and, once confirmed, store the current job in computer memory.

Item 90: The system as in any one of the preceding Items, wherein the instructions, when executed, further cause the at least one programmable processor to add metadata to the job designation based on input from a user interface.

Item 91: The system as in any one of the preceding Items, wherein the instructions, when executed, further cause the at least one programmable processor to: input historical tracking data during use of powered devices at the property location as training data to a machine learning model; train the machine learning model to determine a boundary of the property location; input the tracking data into the machine learning model; and determine, with the machine learning model, an updated boundary of the property location.

Item 92: A non-transitory machine-readable medium storing instructions which, when executed by at least one programmable processor, cause the at least one programmable processor to: receive sensor data from sensors operatively connected to a powered device; determine a state of the powered device based on the sensor data associated with one or more components of the powered device; receive, at a server, tracking data for the powered device; and determine, at the server and based on the state and the tracking data, a property location where the powered device provided the tracking data and the sensor data; build a historical database based on the state and the tracking data; and associate the state and sensor data with the property location.

Item 93: The machine-readable medium as in any one of the preceding Items, wherein the instructions, when executed, further cause the at least one programmable processor to determine a job designation comprising a specific occurrence of operation of the powered device at the property location.

Item 94: The machine-readable medium as in any one of the preceding Items, wherein the instructions, when executed, further cause the at least one programmable processor to determine a percent of completion of a current job based on comparison with the job designation.

Item 95: The machine-readable medium as in any one of the preceding Items, wherein the instructions, when executed, further cause the at least one programmable processor to generate a prompt for a user to confirm the job designation as a current job and, once confirmed, store the current job in computer memory.

Item 96: The machine-readable medium as in any one of the preceding Items, wherein the instructions, when executed, further cause the at least one programmable processor to add metadata to the job designation based on input from a user interface.

Item 97: The machine-readable medium as in any one of the preceding Items, wherein the instructions, when executed, further cause the at least one programmable processor to: input historical tracking data during use of powered devices at the property location as training data to a machine learning model; train the machine learning model to determine a boundary of the property location; input the tracking data into the machine learning model; and determine, with the machine learning model, an updated boundary of the property location.

Item 98: A computer implemented method causing at least one programmable processor to perform operations comprising: receive sensor data from sensors operatively connected to a powered device; determine a state of the powered device based on the sensor data associated with one or more components of the powered device; receive, at a server, tracking data for the powered device; and determine, at the server and based on the state and the tracking data, a property location where the powered device provided the tracking data and the sensor data; build a historical database based on the state and the tracking data; and associate the state and sensor data with the property location.

Item 99: The method as in any one of the preceding Items, wherein the operations, when executed, further cause the at least one programmable processor to determine a job designation comprising a specific occurrence of operation of the powered device at the property location.

Item 100: The method as in any one of the preceding Items, wherein the operations, when executed, further cause the at least one programmable processor to determine a percent of completion of a current job based on comparison with the job designation.

Item 101: The method as in any one of the preceding Items, wherein the operations, when executed, further cause the at least one programmable processor to generate a prompt for a user to confirm the job designation as a current job and, once confirmed, store the current job in computer memory.

Item 102: The method as in any one of the preceding Items, wherein the operations, when executed, further cause the at least one programmable processor to add metadata to the job designation based on input from a user interface.

Item 103: The method as in any one of the preceding Items, wherein the operations, when executed, further cause the at least one programmable processor to: input historical tracking data during use of powered devices at the property location as training data to a machine learning model; train the machine learning model to determine a boundary of the property location; input the tracking data into the machine learning model; and determine, with the machine learning model, an updated boundary of the property location.

Item 104: A system comprising: a powered device; at least one programmable processor; and a non-transitory machine-readable medium storing instructions which, when executed by the at least one programmable processor, cause the at least one programmable processor to: receive sensor data from sensors operatively connected to a powered device; receive supplemental sensor data comprising information indirectly related to operation of the powered device; determine a state based on the sensor data associated with one or more components of the powered device; receive a time of availability of the powered device; determine a time of use of the powered device based on the state of the powered device; and generate, at a client device, a productivity metric based on the time of use, the supplemental sensor data, and the time of availability.

Item 105: The system as in any one of the preceding Items, wherein the powered device is a battery-operated outdoor device.

Item 106: The system as in any one of the preceding Items, wherein the powered device is a mower.

Item 107: The system as in any one of the preceding Items, wherein the powered device is a power drill, a handheld mower, or an electric saw.

Item 108: The system as in any one of the preceding Items, wherein the instructions, when executed, further cause the at least one programmable processor to: compare the productivity metric with a historical average productivity metric; and generate an alert at a client device when the productivity metric is below the historical average productivity metric.

Item 109: The system as in any one of the preceding Items, wherein the instructions, when executed, further cause the at least one programmable processor to: determine an electrical load of the powered device during the time of use, wherein the productivity metric is further based on the electrical load.

Item 110: The system as in any one of the preceding Items, wherein the instructions, when executed, further cause the at least one programmable processor to: input historical times of use of powered devices, historical times of availability of the powered devices, and historical productivity metrics as training data to a machine learning model; train the machine learning model to determine the productivity metric; input the time of use and the time of availability into the machine learning model; and determine, with the machine learning model, the productivity metric.

Item 111: A non-transitory machine-readable medium storing instructions which, when executed by at least one programmable processor, cause the at least one programmable processor to: receive sensor data from sensors operatively connected to a powered device; determine a state based on the sensor data associated with one or more components of the powered device; receive a time of availability of the powered device; determine a time of use of the powered device based on the state of the powered device; and generate, at a client device, a productivity metric based on the time of use and the time of availability.

Item 112: The machine-readable medium as in any one of the preceding Items, wherein the instructions, when executed, further cause the at least one programmable processor to: compare the productivity metric with a historical average productivity metric; and generate an alert at a client device when the productivity metric is below the historical average productivity metric.

Item 113: The machine-readable medium as in any one of the preceding Items, wherein the instructions, when executed, further cause the at least one programmable processor to: determine an electrical load of the powered device during the time of use, wherein the productivity metric is further based on the electrical load.

Item 114: The machine-readable medium as in any one of the preceding Items, wherein the instructions, when executed, further cause the at least one programmable processor to: input historical times of use of powered devices, historical times of availability of the powered devices, and historical productivity metrics as training data to a machine learning model; train the machine learning model to determine the productivity metric; input the time of use and the time of availability into the machine learning model; and determine, with the machine learning model, the productivity metric.

Item 115: A computer implemented method causing at least one programmable processor to perform operations comprising: receive sensor data from sensors operatively connected to a powered device; determine a state based on the sensor data associated with one or more components of the powered device; receive a time of availability of the powered device; determine a time of use of the powered device based on the state of the powered device; and generate, at a client device, a productivity metric based on the time of use and the time of availability.

Item 116: The method as in any one of the preceding Items, wherein the operations, when executed, further cause the at least one programmable processor to: compare the productivity metric with a historical average productivity metric; and generate an alert at a client device when the productivity metric is below the historical average productivity metric.

Item 117: The method as in any one of the preceding Items, wherein the operations, when executed, further cause the at least one programmable processor to: determine an electrical load of the powered device during the time of use, wherein the productivity metric is further based on the electrical load.

Item 118: The method as in any one of the preceding Items, wherein the operations, when executed, further cause the at least one programmable processor to: input historical times of use of powered devices, historical times of availability of the powered devices, and historical productivity metrics as training data to a machine learning model; train the machine learning model to determine the productivity metric; input the time of use and the time of availability into the machine learning model; and determine, with the machine learning model, the productivity metric.

The present disclosure contemplates that the calculations disclosed in the embodiments herein may be performed in a number of ways, applying the same concepts taught herein, and that such calculations are equivalent to the embodiments disclosed. Unless stated otherwise, the term “exemplary” as used herein throughout refers to “example of.”

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. A system comprising:
a powered device;
at least one programmable processor; and
a non-transitory machine-readable medium storing instructions which, when executed by the at least one programmable processor, cause the at least one programmable processor to:
receive sensor data from sensors operatively connected to a powered device;
generate, based on the sensor data, an inventory of detectable items proximate the powered device;
compare the inventory of detectable items to an expected inventory of detectable items that are expected to be proximate the powered device; and
generate an alert at a client device when the inventory of detectable items does not match the expected inventory of detectable items.

2. The system of claim 1, wherein the powered device is a battery-operated outdoor device.

3. The system of claim 2, wherein the powered device is a mower.

4. The system of claim 2, wherein the powered device is a power drill, a handheld mower, or an electric saw.

5. The system of claim 1, wherein the instructions, when executed, further cause the at least one programmable processor to:
generate, at the client device, a last known location of an item from the expected inventory that is not in inventory.

6. The system of claim 1, wherein the instructions, when executed, further cause the at least one programmable processor to:
repeatedly generate the inventory over a period of time based on repeated acquisitions of the sensor data;
monitor the inventory to determine whether the inventory meets a threshold condition for generating the alert; and
generate the alert when the threshold condition is met.

7. The system of claim 6, wherein the threshold condition is a time since last detected for an item in the expected inventory exceeding a maximum time since last detected.

8. The system of claim 6, wherein the threshold condition is a distance for an item in the expected inventory having a last known location exceeding a maximum distance from the powered device.

9. The system of claim 1, wherein the instructions, when executed, further cause the at least one programmable processor to:
perform the comparing when the powered device crosses a speed threshold that is greater than a top speed of the powered device.

10. The system of claim 1, wherein the instructions, when executed, further cause the at least one programmable processor to:
input inventory sets of powered devices as training data to a machine learning model;
train the machine learning model to determine when an item is missing from an input inventory;
input the inventory into the machine learning model; and
determine, with the machine learning model, that the alert should be generated.

11. A non-transitory machine-readable medium storing instructions which, when executed by at least one programmable processor, cause the at least one programmable processor to:
receive sensor data from sensors operatively connected to a powered device;
generate, based on the sensor data, an inventory of detectable items proximate the powered device;
compare the inventory of detectable items to an expected inventory of detectable items that are expected to be proximate the powered device; and
generate an alert at a client device when the inventory of detectable items does not match the expected inventory of detectable items.

12. The machine-readable medium of claim 11, wherein the instructions, when executed, further cause the at least one programmable processor to:
generate, at the client device, a last known location of an item from the expected inventory that is not in inventory.

13. The machine-readable medium of claim 11, wherein the instructions, when executed, further cause the at least one programmable processor to:
repeatedly generate the inventory over a period of time based on repeated acquisitions of the sensor data;
monitor the inventory to determine whether the inventory meets a threshold condition for generating the alert; and
generate the alert when the threshold condition is met.

14. The machine-readable medium of claim 13, wherein the threshold condition is a time since last detected for an item in the expected inventory exceeding a maximum time since last detected.

15. The machine-readable medium of claim 13, wherein the threshold condition is a distance for an item in the expected inventory having a last known location exceeding a maximum distance from the powered device.

16. The machine-readable medium of claim 11, wherein the instructions, when executed, further cause the at least one programmable processor to:
perform the comparing when the powered device crosses a speed threshold that is greater than a top speed of the powered device.

17. The machine-readable medium of claim 11, wherein the instructions, when executed, further cause the at least one programmable processor to:
input inventory sets of powered devices as training data to a machine learning model;
train the machine learning model to determine when an item is missing from an input inventory;
input the inventory into the machine learning model; and
determine, with the machine learning model, that the alert should be generated.

18. A computer implemented method causing at least one programmable processor to perform operations comprising:
receive sensor data from sensors operatively connected to a powered device;
generate, based on the sensor data, an inventory of detectable items proximate the powered device;
compare the inventory of detectable items to an expected inventory of detectable items that are expected to be proximate the powered device; and
generate an alert at a client device when the inventory of detectable items does not match the expected inventory of detectable items.

19. The method of claim 18, wherein the operations, when executed, further cause the at least one programmable processor to:
generate, at the client device, a last known location of an item from the expected inventory that is not in inventory.

20. The method of claim 18, wherein the operations, when executed, further cause the at least one programmable processor to:
repeatedly generate the inventory over a period of time based on repeated acquisitions of the sensor data;
monitor the inventory to determine whether the inventory meets a threshold condition for generating the alert; and
generate the alert when the threshold condition is met.

21. The method of claim 20, wherein the threshold condition is a time since last detected for an item in the expected inventory exceeding a maximum time since last detected.

22. The method of claim 20, wherein the threshold condition is a distance for an item in the expected inventory having a last known location exceeding a maximum distance from the powered device.

23. The method of claim 18, wherein the operations, when executed, further cause the at least one programmable processor to:
perform the comparing when the powered device crosses a speed threshold that is greater than a top speed of the powered device.

24. The method of claim 18, wherein the operations, when executed, further cause the at least one programmable processor to:
input inventory sets of powered devices as training data to a machine learning model;
train the machine learning model to determine when an item is missing from an input inventory;
input the inventory into the machine learning model; and
determine, with the machine learning model, that the alert should be generated.
